(19) United States
(12) Patent Application Publication
(10) Pub. No.: US 2005/0264856 A1
(43) Pub. Date: Dec. 1, 2005

(54) Cylindrical outer surface scanning apparatus and method for use therewith

(75) Inventors: Shiro Kitawaki, Kyoto (JP); Yoshitomo Wada, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/100,580

(22) Filed: Apr. 7, 2005

(30) Foreign Application Priority Data
Apr. 28, 2004 (JP) 2004-133761

(51) Int. Cl. H04N 1/04

(52) U.S. Cl. 358/493

(57) ABSTRACT

A trailing-end sensor 81 is provided in the neighborhood of a trailing-end clamp 53. The trailing end sensor 81 detects whether or not a plate is located at its sensing point. Based on the trailing end position of the plate P detected by the trailing-end sensor 81, a rotational angle position of a recording drum 5 is fixed at a trailing-end clamp position, where the trailing end of the plate P is clamped by the trailing-end clamp 53. Thus, it is possible to securely stabilize the plate P by means of the trailing-end clamp 53, and stably ensure a gripper margin of the plate P by the trailing-end clamp 53 regardless of the plate-to-plate variations which may occur in the manufacturing process.

### BACKGROUND OF THE INVENTION

1. Field of the Invention

The present invention relates to a cylindrical outer surface scanning apparatus and a method for use therewith, more particularly, relates to a cylindrical outer surface scanning apparatus which positions a sheet-shaped image recording material in place on the outer surface of a recording drum for mounting the image recording material thereon, and a method for use with the cylindrical outer surface scanning apparatus.

2. Related Art Statement

Conventionally, color printed materials are produced through a number of processes such as an exposure process (which serves as an image recording process), a printing process, and the like. Prior to the exposure process, an original image of a color printed material is separated into a plurality of colors, which typically are: Y (Yellow), M (Magenta), C (Cyan), and K (Kuro, i.e., “black”). Thus, image data of the respective colors are generated. Such image data are supplied to an image recording apparatus which is used for an exposure process. For example, the image recording apparatus may be a cylindrical outer surface scanning apparatus incorporating a recording drum with a sheet-shaped image recording material being mounted on the outer surface thereof for scanning. On the outer surface of the recording drum, a sheet-shaped plate which serves as an image recording material, e.g., a so-called PS plate(Presensitized Plate) or a thermal plate, is mounted. A “PS plate” is a plate comprising a plate material (e.g., an aluminum plate, a plastic sheet, or paper) and a photo-sensitive layer preapplied on the plate material.

In the exposure process, the cylindrical outer surface scanning apparatus subjects the plate which is mounted on the outer surface of the recording drum to an exposure process in order to form an image of each of the respective separated colors on the plate based on the image data thus supplied. In other words, in the case where the original image is color-separated into Y, M, C, and K, the cylindrical outer surface scanning apparatus draws images of the four different colors on four plates.

A printing machine which is used in a printing process applies inks to the plates which have been exposed, each ink being in a color corresponding to the associated plate, so as to overlay the respective images on a final color printed material. If the images of one or more colors are misaligned with each other when overlaid, the resulting color printed material will be of an inferior quality. In order to prevent such misalignment between images, positioning holes for the printing process, which are used as a positioning reference during the printing process, are formed in predetermined positions in the plate, prior to the exposure process. Each plate can be positioned in place by fitting pins which are provided on a printing drum of the printing machine into the positioning holes for the printing process. In some cases, e.g., where the specific printing machine to be used is still undecided at the prepress stage, the positioning holes for the printing process may be formed after the prepress.

Misalignments between images may also occur if the positions of one or more images drawn during the exposure process are misaligned with respect to the plates of the corresponding colors. In order to prevent such image misalignments with respect to the plates during the exposure process, the leading end of the plate is positioned with respect to the outer surface of the recording drum of the cylindrical outer surface scanning apparatus, and pressed against the recording drum by a leading-end clamp. The trailing end of the plate is also pressed against the recording drum by a trailing-end clamp. In order to appropriately clamp the trailing end of the plate by the trailing-end clamp, it is necessary to ensure a so-called “gripper margin” where the trailing-end clamp comes in contact with the plate, and set a trailing-end clamp position so as not to overlap an image recording area of the plate. U.S. Pat. No. 6,164,204, for example, discloses a drawing apparatus which attaches/detaches such a trailing-end clamp to/from the recording drum.

FIG. 33 is a schematic side view illustrating one example of a plate P having been mounted and wound around the outer surface of a recording drum 100. In FIG. 33, the leading end of the plate P is clamped on the outer surface of the recording drum 100 by a leading-end clamp 101, and the trailing end thereof is clamped on the outer surface of the recording drum 100 by a trailing-end clamp 102. Assume that the circumferential length of the plate P wound around the recording drum 100 is L, and the thickness of the plate P is T. When the plate P is manufactured, plate-to-plate variation may occur in the process of manufacturing. For example, the length L may vary due to a cutting error a, and the thickness T may vary due to a thickness error b. Therefore, the angle θ from the leading end to the trailing end of the plate P wound around the outer surface of the recording drum 100 with a diameter of φD is obtained by the following equation: θ=360(L±a)/π{D+(T±b)}. On the other hand, positioning error may occur when the leading end of the plate P is positioned by the leading-end clamp 101. In other words, a position of the trailing end of the plate P mounted on the outer surface of the recording drum 100 may be displaced due to numerous manufacturing variations. Thus, it is necessary to set the above-mentioned “gripper margin” to be long enough in case these variations occur, whereby an image recordable area of a principal area of the plate P will be reduced.

Also, in the drawing apparatus as disclosed in U.S. Pat. No. 6,164,204, the trailing-end clamp is stabilized in accordance with the standards including a design value of the plate P, whereby it is necessary to set the “gripper margin” to be long enough in case the above-described variations occur.

### SUMMARY OF THE INVENTION

Therefore, an object of the present invention is to provide a cylindrical outer surface scanning apparatus and a method for use therewith which are capable of reducing a gripper margin for use in clamping the trailing end of a sheet-shaped image recording material by a trailing-end clamp when the image recording material is mounted on the outer surface of a recording drum for image recording, and obtaining a sufficient image recording area of the image recording material.

The present invention has the following features to attain the object mentioned above. A first aspect of the present invention is directed to a cylindrical outer surface scanning apparatus for recording an image on a sheet-shaped image recording material mounted thereon. The cylindrical outer surface scanning apparatus comprises: a cylindrical drum; a leading end stabilizing section; winding means; a trailing end detecting section; a trailing end stabilizing section; a control section; and driving means. The cylindrical drum mounts the image recording material on the outer surface thereof. The leading end stabilizing section positions the leading end of the image recording material on the outer surface of the drum for stabilization. The winding means winds the image recording material whose leading end is stabilized by the leading end stabilizing section around the outer surface of the drum in the circumferential direction thereof. The trailing end detecting section detects a position of the trailing end of the image recording material on the outer surface of the drum in the circumferential direction of the outer surface of the drum. The trailing end stabilizing section is provided on the drum so as to be releasable therefrom and movable in the circumferential direction. The trailing end stabilizing section stabilizes the trailing end of the image recording material on the outer surface of the drum. The control section sets a position in the circumferential direction at which the trailing end stabilizing section is attached on the drum, based on the circumferential direction position of the trailing end detected by the trailing end detecting section. The driving means attaches the trailing end stabilizing section at the circumferential direction position on the outer surface of the drum set by the control section.

According to a second aspect, in the first aspect, the trailing end detecting section detects the trailing end of the image recording material at a plurality of portions along the cylindrical axis direction of the outer surface of the drum.

According to a third aspect, in the first aspect, the control section sets the circumferential direction position at which the trailing end stabilizing section is attached on the drum such that the trailing end of the image recording material pinched between the trailing end stabilizing section and the outer surface of the drum is constant in length in the circumferential direction.

According to a fourth aspect, in the first aspect, a roller is further included. The roller presses the image recording material against the outer surface of the drum when the image recording material is wound around the outer surface of the drum by the winding means. The trailing end detecting section detects the trailing end of the image recording material in the neighborhood of the roller.

According to a fifth aspect, in the first aspect, the control section sets the circumferential direction position at which the trailing end stabilizing section is attached on the drum by adjusting the circumferential direction position of the trailing end detected by the trailing end detecting section based on a type of image recording material.

A sixth aspect of the present invention is directed to a cylindrical outer surface scanning method for recording an image on a sheet-shaped image recording material mounted on a cylindrical outer surface of a cylindrical drum. The cylindrical outer surface scanning method comprises a leading end stabilizing step; a winding step; a trailing end detecting step; a trailing end stabilizing member position setting step; and an attaching step. The leading end stabilizing step stabilizes the leading end of the image recording material on the outer surface of the drum after positioning. The winding step winds the image recording material whose leading end is stabilized at the leading end stabilizing step around the outer surface of the drum in the circumferential direction thereof. The trailing end detecting step detects a position of a trailing end of the image recording material wound around the outer surface of the drum in the circumferential direction of the outer surface of the drum. The trailing end stabilizing member position setting step sets a position in the circumferential direction at which a trailing end stabilizing member for stabilizing the trailing end of the image recording material on the outer surface of the drum is attached on the drum, based on the circumferential direction position of the trailing end of the image recording material detected at the trailing end detecting step. The attaching step attaches the trailing end stabilizing member at the circumferential direction position of the outer surface of the drum set at the trailing end stabilizing member position setting step.

According to a seventh aspect, in the sixth aspect, the trailing end detecting step detects the trailing end of the image recording material at a plurality of portions along the cylindrical axis direction of the outer surface of the drum.

According to an eighth aspect, in the sixth aspect, the trailing end stabilizing member position setting step sets the circumferential direction position at which the trailing end stabilizing member is attached on the drum such that the trailing end of the image recording material pinched between the trailing end stabilizing member and the outer surface of the drum is constant in length in the circumferential direction.

According to a ninth aspect, in the sixth aspect, the winding step presses a portion of the image recording material against the outer surface of the drum when the image recording material is wound around the outer surface of the drum. The trailing end detecting step detects the trailing end of the image recording material in the neighborhood of the portion of the image recording material which is pressed against the outer surface at the winding step.

According to a tenth aspect, in the sixth aspect, the trailing end stabilizing member position setting step sets the circumferential direction position at which the trailing end stabilizing member is attached on the drum by adjusting the circumferential direction position of the trailing end detected at the trailing end detecting step based on a type of image recording material.

According to the first aspect, the trailing end position of the image recording material is detected while the image recording material is being wound around the outer surface of the drum, whereby the trailing end stabilizing section is attached on the drum based on the detected trailing end position of the image recording material. Thus, it is possible to securely stabilize the image recording material by means of the trailing end stabilizing section, and stably ensure a gripper margin of the image recording material by the trailing end stabilizing section regardless of the variations in image recording material which may occur in the manufacturing process.

According to the second aspect, even if the trailing end of the image recording material is tilted with respect to the cylindrical axis of the drum, it is possible to stably detect the trailing end of the image recording material.

According to the third aspect, it is possible to set a gripper margin smaller than the conventional gripper margin, which is set so as to be long enough in case of the manufacturing variations occur, and obtain a sufficient image recording area of the image recording material.

According to the fourth aspect, since the trailing end of the image recording material is detected during the winding of the image recording material, variations may occur due to a difference in rigidity (stiffness) of the image recording material. The trailing end of the image recording material is stabilized in the neighborhood of the roller where the image recording material is pressed against the outer surface of the drum. Thus, by detecting the trailing end of the image recording material in the neighborhood of the roller, it is possible to prevent the occurrence of variations due to a difference in the stiffness of the image recording material.

According to the fifth aspect, it is possible to set the circumferential direction position at which the trailing end stabilizing section is attached on the drum in accordance with the variations in detected trailing end, which occur due to a difference in type of image recording material (e.g., stiffness and reflectivity).

According to the cylindrical outer surface scanning method of the present invention, the effect similar to that of the above-described cylindrical outer surface scanning apparatus can be achieved.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded view showing a cylindrical outer surface scanning apparatus according to one embodiment of the present invention;

FIG. 2 is a cross-sectional view of a storage/transportation mechanism 2, taken at a dash-dot line A-A′ and as seen in the direction of arrow B in FIG. 1;

FIG. 3 is a view showing a drive mechanism 3 as seen in the direction of arrow C in FIG. 1;

FIG. 4 is an exploded view of the drive mechanism 3 shown in FIG. 3;

FIG. 5A is a diagram for illustrating a lower position in the operation of the drive mechanism 3 shown in FIGS. 3 and 4;

FIG. 5B is a diagram for illustrating an upper position in the operation of the drive mechanism 3 shown in FIGS. 3 and 4;

FIG. 6 is a cross-sectional view showing a punch unit 4, taken at a dash-dot line E-E′ and seen in the direction of arrow F in FIG. 1;

FIG. 7 is a perspective view showing the punch unit 4 and a recording drum 5 shown in FIG. 1 as well as the vicinity thereof;

FIG. 8 is a cross-sectional view showing the recording drum 5 as well as the vicinity thereof, taken at a dash-dot line G-G′ and as seen in the direction of arrow H in FIG. 1;

FIG. 9 is a schematic side view illustrating a plate P having been supplied in a lower tray 22 of the storage/transportation mechanism 2;

FIG. 10 is a schematic side view illustrating a first supply path line;

FIG. 11 is a schematic side view illustrating forward rotations of a feed roller 24 and transportation rollers 25;

FIG. 12 is a schematic side view illustrating reverse rotations of the feed roller 24 and the transportation rollers 25;

FIG. 13 is a schematic side view illustrating a first angular position X of a leading-end clamp 52;

FIG. 14 is a schematic side view illustrating forward rotations of the feed roller 24 and the transportation rollers 25 during the loading of the plate P;

FIG. 15 is a schematic side view illustrating how the plate P is wound around the outer surface of the recording drum 5 due to a forward rotation thereof;

FIG. 16 is a schematic side view illustrating the leading-end clamp 52 having moved in a circular motion by an angle Y from the first angular position X due to the rotation of the recording drum 5;

FIG. 17 is a schematic side view illustrating a positional relationship of the recording drum 5, a trailing-end clamp 53, a squeeze roller 56, and a trailing-end sensor 81 as seen in the direction of arrow H in FIG. 1;

FIG. 18 is a perspective view illustrating a positional relationship of the recording drum 5, the trailing-end clamp 53, the squeeze roller 56, and the trailing-end sensor 81 as seen in the direction of arrow I in FIG. 17;

FIG. 19 is a perspective view illustrating a positional relationship of the recording drum 5, the trailing-end clamp 53, the squeeze roller 56, and the trailing-end sensor 81 as seen in the direction of arrow J in FIG. 17;

FIG. 20 is an exploded perspective view of the trailing-end clamp 53;

FIG. 21A is a longitudinal cross-sectional view of a portion of the trailing-end clamp 53 inserted in a clamp groove 58;

FIG. 21B is a longitudinal cross-sectional view of a portion of the trailing-end clamp 53 fixed to the clamp groove 58;

FIG. 22 is a horizontal cross-sectional view of the trailing-end clamp 53;

FIG. 23 is a side view illustrating how the trailing-end clamp 53 is attached to the recording drum 5 by a third clamp driving section 9;

FIG. 24 is a side view illustrating how the trailing-end clamp 53 is separated from the third clamp driving section 9 after being stabilized on the recording drum 5;

FIG. 25 is a flowchart illustrating a sequence for mounting the plate P on the recording drum 5;

FIG. 26A is a schematic diagram illustrating a first state during the first half of the operation for mounting the plate P on the recording drum 5;

FIG. 26B is a schematic diagram illustrating a second state during the first half of the operation for mounting the plate P on the recording drum 5;

FIG. 26C is a schematic diagram illustrating a third state during the first half of the operation for mounting the plate P on the recording drum 5;

FIG. 26D is a schematic diagram illustrating a fourth state during the first half of the operation for mounting the plate P on the recording drum 5;

FIG. 27A is a schematic diagram illustrating a fifth state during the last half of the operation for mounting the plate P on the recording drum 5;

FIG. 27B is a schematic diagram illustrating a sixth state during the last half of the operation for mounting the plate P on the recording drum 5;

FIG. 27C is a schematic diagram illustrating a seventh state during the last half of the operation for mounting the plate P on the recording drum 5;

FIG. 27D is a schematic diagram illustrating an eighth state during the last half of the operation for mounting the plate P on the recording drum 5;

FIG. 28 is a schematic diagram illustrating a positional relationship of the trailing end position of the plate P, which is detected by the trailing-end sensor 81, and the trailing-end clamp position;

FIG. 29 is a schematic diagram illustrating the trailing end of the plate P having being detected by the trailing-end sensor 81;

FIG. 30 is a flowchart illustrating a sequence for removing the plate P from the recording drum 5;

FIG. 31A is a schematic diagram illustrating a first state during the first half of the operation for removing the plate P from the recording drum 5;

FIG. 31B is a schematic diagram illustrating a second state during the first half of the operation for removing the plate P from the recording drum 5;

FIG. 31C is a schematic diagram illustrating a third state during the first half of the operation for removing the plate P from the recording drum 5;

FIG. 31D is a schematic diagram illustrating a fourth state during the first half of the operation for removing the plate P from the recording drum 5;

FIG. 32A is a schematic diagram illustrating a fifth state during the last half of the operation for removing the plate P from the recording drum 5;

FIG. 32B is a schematic diagram illustrating a sixth state during the last half of the operation for removing the plate P from the recording drum 5;

FIG. 32C is a schematic diagram illustrating a seventh state during the last half of the operation for removing the plate P from the recording drum 5;

FIG. 32D is a schematic diagram illustrating an eighth state during the last half of the operation for removing the plate P from the recording drum 5; and

FIG. 33 is a schematic side view illustrating one example of the plate P having been mounted and wound around the outer surface of a conventional recording drum 100.

### DESCRIPTION OF THE PREFERRED EMBODIMENTS

With reference to the drawings, a cylindrical outer surface scanning apparatus according to one embodiment of the present invention will be described. Hereinafter, a sheet-shaped plate, e.g., a so-called PS plate (Presensitized Plate) or a thermal plate, is taken as an exemplary image recording material to be mounted on the outer surface of a recording drum of the cylindrical outer surface scanning apparatus. A “PS plate” is a plate comprising a plate material (e.g., an aluminum plate, a plastic sheet, or paper) and a photo-sensitive layer preapplied on the plate material.

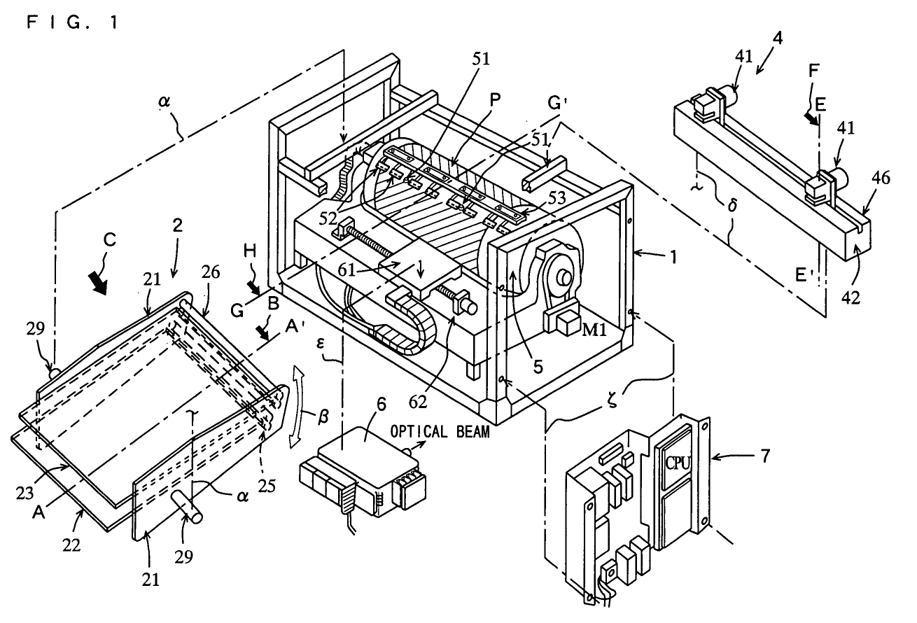

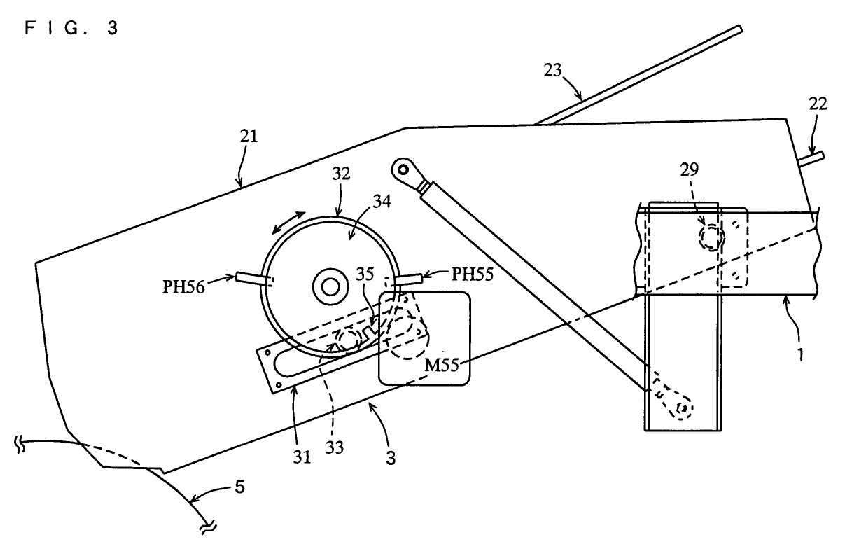

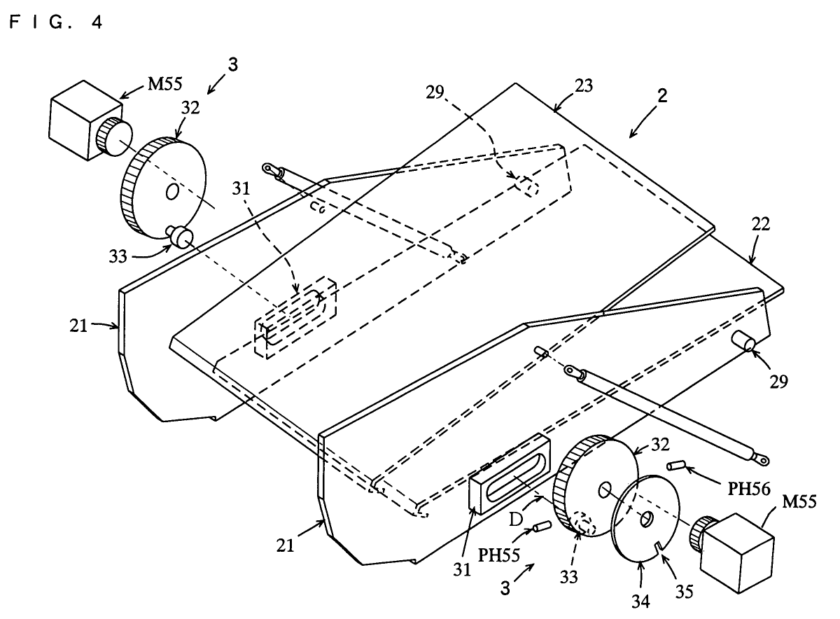

FIG. 1 is an exploded view showing the cylindrical outer surface scanning apparatus. The cylindrical outer surface scanning apparatus comprises a frame 1 which is in the shape of a generally rectangular solid. On the frame 1, a storage/transportation mechanism 2, a drive mechanism 3 (not shown; see 3 in FIGS. 3 and 4), a punch unit 4, a recording drum 5, an exposure head 6, and an electrical circuitry section 7 are mounted. For clarity, the drive mechanism is not shown in FIG. 1.

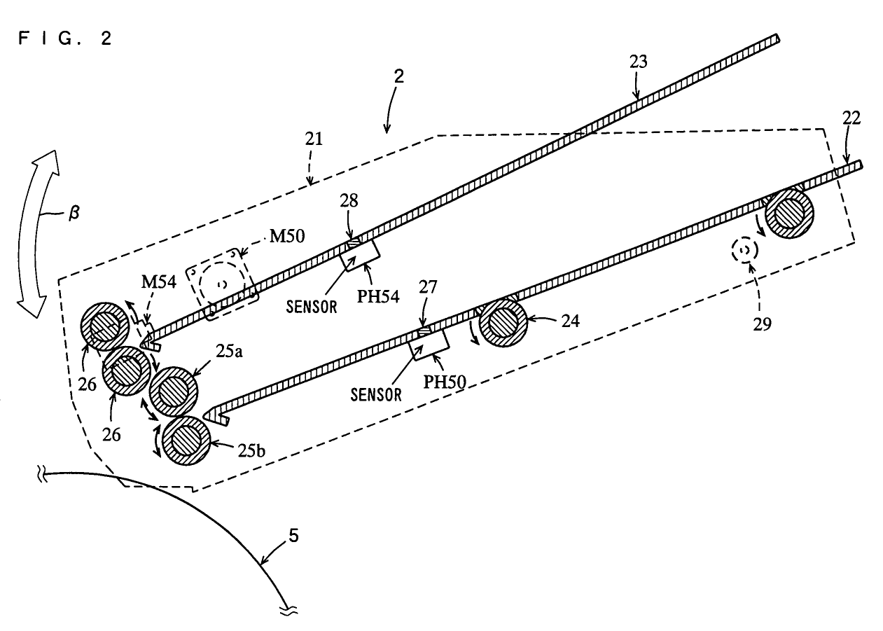

FIG. 2 is a cross-sectional view of the storage/transportation mechanism 2, taken at a dash-dot line A-A′ and as seen in the direction of arrow B in FIG. 1. Note that not all of the component elements shown in FIG. 2 are shown in FIG. 1. As shown in FIGS. 1 and 2, the storage/transportation mechanism 2 comprises: two trays 22 and 23 which are fixed by being interposed between two side plates 21; a feed roller 24; a pair of transportation rollers 25 for loading purposes; and a pair of transportation rollers 26 for unloading purposes. Thus, by means of the two side plates 21, the two trays 22 and 23 are held together in an integral manner, so that the tray 23 comes generally above the tray 22. Since the tray 23 comes generally above the tray 22, the tray 23 will hereinafter be referred to as an “upper tray 23”, and the tray 22 as a “lower tray 22”.

The feed roller 24 is a roller for transporting a plate which is accommodated in the lower tray 22 in the direction of the transportation rollers 25. The pair of transportation rollers 25, and the pair of transportation rollers 26, are disposed in the manner of a bridge astride one of the side plates 21 and the other side plate 21. The pair of transportation rollers 25 are disposed in the neighborhood of the leading end of the lower tray 22, in such a manner that the two rollers abut each other from above and from below. The upper transportation roller 25a can be driven to move up and down by means of a transportation roller up/down drive (not shown). Furthermore, the pair of transportation rollers 26 are disposed in the neighborhood of the leading end of the upper tray 23, in such a manner that two rollers abut each other. The feed roller 24 and the transportation rollers 25 are coupled via a belt (not shown) to a motor M50 which is fixed on one of the side plates 21, so as to be rotated by a driving force generated by the motor M50. The transportation rollers 26 are coupled via a belt (not shown) to a motor M54 which is fixed on one of the side plates 21, so as to be rotated by a driving force generated by the motor M54.

Small holes 27 and 28 are formed in predetermined positions of the lower tray 22 and the upper tray 23. Sensors PH50 and PH54 are fixed immediately under the small holes 27 and 28, respectively. The sensors PH50 and PH54 detect whether or not a plate is present above the small holes 27 and 28.

The storage/transportation mechanism 2 having the above structure is fixed in an upper portion of the frame 1 as indicated by a dash-dot arrow α in FIG. 1, so as to be capable of rotating within a predetermined range (see arrow β in FIGS. 1 and 2) around a center of rotation defined by a rotation axis 29 protruding outward from the two side plates 21. The drive mechanism 3 realizes the rotation of the storage/transportation mechanism 2. FIG. 3 is a view showing the drive mechanism 3 as seen in the direction of arrow C in FIG. 1. FIG. 4 is an exploded view of the drive mechanism 3 shown in FIG. 3.

In FIGS. 3 and 4, the drive mechanism 3 comprises a pair of cam follower guides 31, a pair of motors M55, a pair of cam gears 32, and a pair of cam followers 33, and at least one sensor detection plate 34, at least one sensor PH55, and at least one PH56. Each cam follower guide 31 has an outer shape of a rectangular solid, with elongated-circular through holes being formed in the rectangular solid. The cam follower guides 31 are fixed on the side plates 21, one on each side plate, in such a manner that the two through holes oppose each other with the storage/transportation mechanism 2 generally interposed therebetween (see FIG. 4). The motors M55 are disposed in the neighborhood of the respective side plates 21 so as to oppose each other, with the storage/transportation mechanism 2 interposed therebetween, and fixed on the frame 1. The cam gears 32 are fixed on the frame 1 so as to face the respective side plates 21, in such a manner that each cam gear 32 is capable of rotating around its axis with a driving force generated by the corresponding motor M55. Each cam follower 33, which is fixed at the outer edge of a face of the corresponding cam gear 32 facing the side plate 21, rotates in a circular motion around the axis of the cam gear 32. Each cam follower 33 has a disk shape with a diameter substantially identical to the shorter width of the through hole in the cam follower guide 31, so that the cam follower 33 is received in the through hole as indicated by a dash-dot arrow D in FIG. 4. As a result, each cam follower guide 31 and the corresponding cam gear 32 are coupled by means of the cam follower 33, whereby the storage/transportation mechanism 2 is supported by the drive mechanism 3.

Each disk-shaped sensor detection plate 34, which is disposed concentrically with the corresponding cam gear 32, rotates along with the cam gear 32. A slit 35 is formed in the outer periphery of each sensor detection plate 34. The sensors PH55 and PH56 are fixed on the frame 1 in such a manner as to be capable of detecting the slit 35 formed in the corresponding rotating sensor detection plate 34.

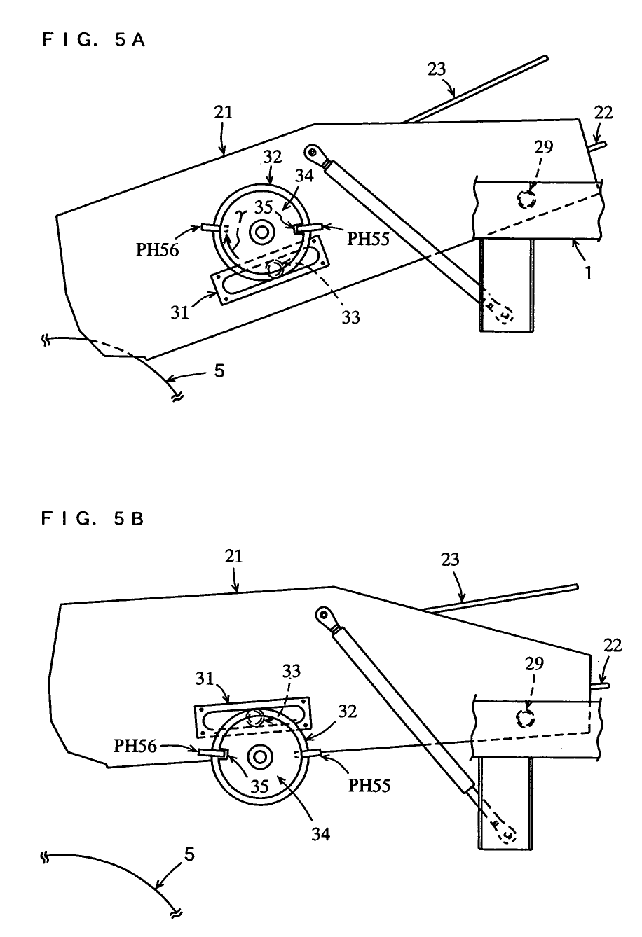

Now, the operation of the drive mechanism 3 having the above structure will be described with reference to FIGS. 5A and 5B. For clarity, the motor M55 is not shown in FIGS. 5A and 5B. In FIG. 5A, the slit 35 in the sensor detection plate 34 is being detected by the sensor PH55 because the slit 35 is situated immediately above the sensor PH55. When the slit 35 is being detected by the sensor PH55, each cam follower 33 is situated in the vicinity of the lowermost end of the circular motion thereof. Therefore, the storage/transportation mechanism 2 is being supported by the drive mechanism 3 at a position (hereinafter referred to as a “lower position”) corresponding to the vicinity of the lowermost end of the circular motion of each cam follower 33. In this situation, as each cam gear 32 begins to rotate in a direction indicated by arrow y due to a driving force generated by the corresponding motor M55, the corresponding cam follower 33 begins a circular motion in that direction, i.e., in an upper direction from the vicinity of the lowermost end of the circular motion of each cam follower 33. As a result, each cam follower 33 causes the storage/transportation mechanism 2, on which the corresponding cam follower guide 31 is fixed, to move in the upper direction from the lower position.

As shown in FIG. 5B, the rotation of the cam gear 32 causes the slit 35 in the sensor detection plate 34 to move in a circular motion in the direction of arrow y from the position immediately above the sensor PH55, until the slit 35 comes immediately above the sensor PH56. The sensor PH56 detects the slit 35 situated immediately above the sensor PH56. When the slit 35 is detected by the sensor PH56, the motor M55 stops the generation of the driving force. As a result, each cam follower 33 is situated in the vicinity of the uppermost end of the circular motion of each cam follower 33, and the storage/transportation mechanism 2 is halted at a position (hereinafter referred to as an “upper position”) corresponding to the vicinity of the uppermost end of the circular motion of each cam follower 33 while being supported by the drive mechanism 3. Through the above operation of the drive mechanism 3, the storage/transportation mechanism 2 moves up and down between its lower position and upper position.

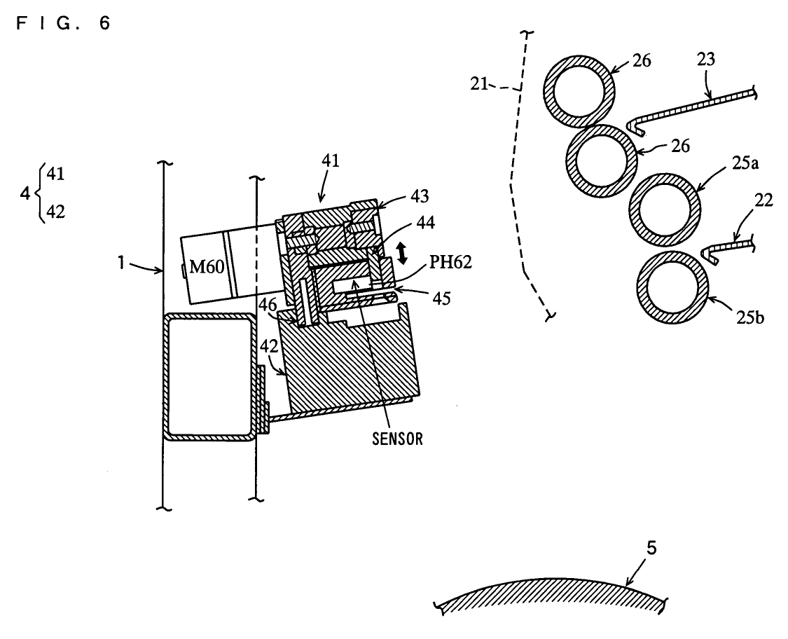

Next, the punch unit 4 shown in FIG. 1 will be described. FIG. 6 is a cross-sectional view showing the punch unit 4, taken at a dash-dot line E-E′ in FIG. 1 and seen in the direction of arrow F. As shown in FIG. 1, the punch unit 4 includes at least two punchers 41 and an attachment member 42. As shown in FIG. 6, each puncher 41 includes a main body 43, a sensor PH62, a motor M60, and a punch 44. The main body 43 has an inlet 45 formed therein. A plate which comes transported along a first supply path line (described below) is inserted in the inlet 45. The sensor PH62 detects whether or not a plate has been inserted in the inlet 45.

Upon detection of a plate by the sensor PH62, the motor M60 generates a driving force based on the control by the electrical circuitry section 7. The driving force generated by the motor M60 is converted to a force for moving the punch 44 up and down by means of a cam mechanism (not shown) within the main body. The punch 44 moves up and down due to the force which has been transmitted from the cam mechanism, so as to punch a hole in the plate which is placed in the inlet 45. As a result, a positioning notch or a non-contacting notch is formed at one end of the plate.

The attachment member 42 has the shape of a generally rectangular solid. A groove 46 is formed along a longitudinal direction of the attachment member 42. The respective punchers 41 are attached in the groove 46. In stead of forming the groove 46 in the attachment member 42, the punchers 41 may be affixed by means of knock holes, bolt holes, and the like. The punch unit 4 having the above structure is fixed on the frame 1, as indicated by a dash-dot arrow δ in FIG. 1.

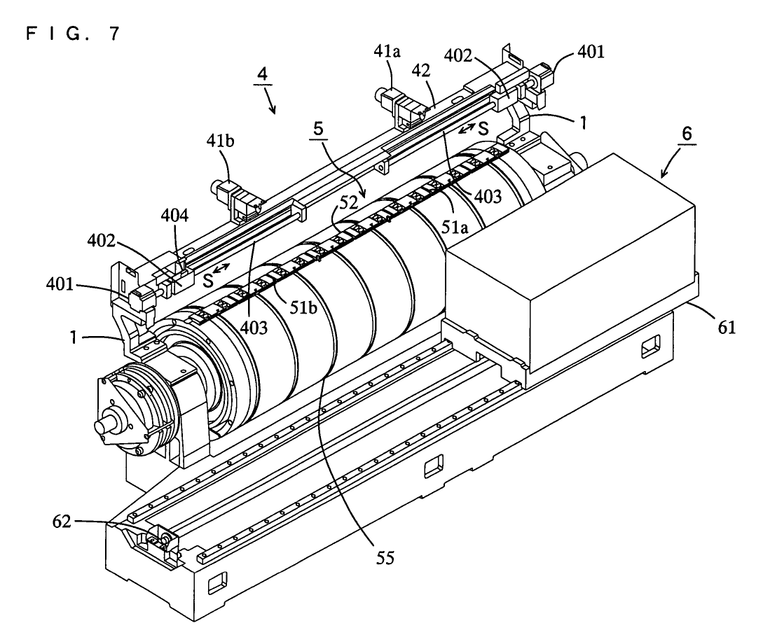

FIG. 7 is a perspective view showing the punch unit 4, the recording drum 5, and the exposure head 6, which are fixed to the frame 1 in the above-described manners. For clarity, the storage/transportation mechanism 2, the drive mechanism 3, and the electrical circuitry section 7 are omitted from FIG. 7. Although positioning punchers for punching holes used in conjunction with a printing machine may also be mounted on the punch unit 4, only the positioning punchers 41 for punching holes used in conjunction with the recording drum are illustrated for conciseness. The positioning punchers for punching holes used in conjunction with a printing machine may be fixed on the attachment member 42, for example, between the positioning punchers 41 for punching holes used in conjunction with the recording drum.

As shown in FIG. 7, two punchers 41a and 41b are fixed on the attachment member 42. At opposite ends of the front face of the attachment member 42, centering motors 401 are fixed. The centering motors 401 respectively drive a pair of ball screws 403, which extend in the horizontal direction along the front face of the attachment member 42 and which are capable of rotating. A centering bearing 402 is in screw-engagement with each ball screw 403. On an upper face of each centering bearing 402, a cylindrical retention member 404 capable of rotating is provided (note that one of the retention members 404 is not shown in FIG. 7). Thus, as the centering motors 401 run, the centering bearings 402 move in an S direction shown in FIG. 7.

When the plate is introduced into the punch unit 4, the plate is placed between the pair of centering bearings 402. When the centering motors 401 run so as to move the pair of centering bearings 402 toward the center from predetermined original positions, the outer surfaces of the retention members 404 on the centering bearing 402 abut the end faces of the plate on both sides, thereby positioning the plate in the center of the attachment member 42 (hence, this mechanism will be referred to as a “centering mechanism”).

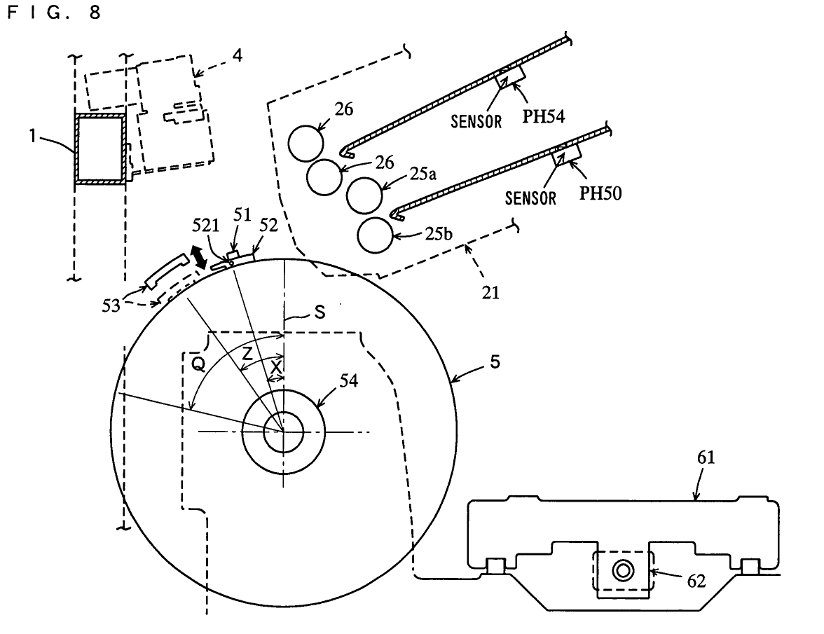

Next, referring to FIGS. 1, 7, and 8, the recording drum 5 will be described. FIG. 8 is a cross-sectional view showing the recording drum 5 and the vicinity thereof, taken at a dash-dot line G-G′ in FIG. 1 and as seen in the direction of arrow H. Referring to FIGS. 1, 7, and 8, the recording drum 5 is disposed within the frame 1 so that the recording drum 5 is located obliquely below the storage/transportation mechanism 2 and the punch unit 4. The recording drum 5 having a generally cylindrical shape rotates around the cylindrical axis due to a driving force generated by the motor M1. A plate P (corresponding to the portion hatched with oblique line in FIG. 1), which comes transported along a second supply path line (described below), is mounted and wound around the outer surface (annular surface) of the recording drum 5.

As a structure for stabilizing the plate P on the outer surface of the recording drum 5, the cylindrical outer surface scanning apparatus comprises at least two positioning pins 51, leading-end clamps 52, and trailing-end clamps 53. The positioning pins 51 are fixed on the outer surface of the recording drum 5, and arranged so that it is possible to clamp one end (i.e., the leading end) of the plate P which comes transported along the second supply path line (described below) while the positioning pins 51a and 51b fit in respective positioning notches created by the punchers 41a and 41b. The trailing-end clamp 53 is configured so as to be releasable from the outer surface of the recording drum 5. While the trailing-end clamp 53 is released from the recording drum 5, the trailing-end clamp 53 is retained by a third clamp driving section (not shown) (details thereof will be described below). Once attached on the recording drum 5, the trailing-end clamp 53 functions to clamp the other end (i.e., the trailing end) of the plate P which comes transported along the second supply path line (described below).

A rotary encoder 54 is attached to the rotation axis of the recording drum 5 to detect various angular positions thereof. In the present cylindrical outer surface scanning apparatus, a first angular position X, a second angular position Z, and a third angular position Q are previously defined. Specifically, the leading-end clamp 52 clamps at the first angular position X; the second angular position Z concerns the positioning of the trailing-end clamp 53; and the clamping of the leading-end clamp 52 is released at the third angular position Q. As shown in FIG. 8, each angular position is defined relative to a predetermined reference lines. While the recording drum 5 is in the first angular position X, the leading-end clamp 52 is driven by the first clamp driving section (not shown) to clamp the leading end of the plate P. While the recording drum 5 is in the third angular position Q, the leading-end clamp 52 is driven by a second clamp driving section (not shown) to release the leading end of the plate P which has been clamped. While the recording drum 5 is in the second angular position Z, the trailing-end clamp 53 may be driven by a third clamp driving section (not shown) to be attached on the outer surface of the recording drum 5 so as to clamp the trailing end of the plate P. The trailing-end clamp 53 thus attached on the outer surface may be taken off the outer surface by the third clamp driving section while the recording drum 5 is in the second angular position Z, thereby releasing the trailing end of the plate P. Since the first and second clamp driving sections do not constitute an essential portion of the present invention, any detailed description thereof will be omitted. Detailed description of the third clamp driving section will be described below.

Furthermore, as a structure for keeping the plate P in close contact with the outer surface of the recording drum 5, the cylindrical outer surface scanning apparatus comprises: a plurality of small holes and grooves (hereinafter referred to as “suction holes” and “suction grooves 55”) provided on the outer surface of the recording drum 5 for plate suction purposes; a blower (not shown) which cooperates with the suction holes and the suction groove 55 to create a vacuum system; and a squeeze roller (described below) disposed in the neighborhood of the recording drum 5. Since the suction holes, the suction groove 55, and the blower do not constitute an essential portion of the present invention, any detailed description thereof will be omitted. A groove for trailing-end clamp attachment purposes is formed on the outer surface of the recording drum 5, and details thereof will be described below.

Next, the exposure head 6 will be described. As indicated by a dash-dot line ε in FIG. 1 and as illustrated in FIG. 7, the exposure head 6 is disposed on a table 61 which is provided in a close vicinity of the recording drum 5. While being conveyed in a direction parallel to the rotation axis of the recording drum 5 due to a driving force generated by a feed screw mechanism 62, the exposure head 6 scans the plate P (which is rotating with the recording drum 5) with light beams which have been modified based on image data supplied from the electrical circuitry section 7 (described below). Thus, the exposure head 6 performs an exposure process to record an image on the plate P.

The electrical circuitry section 7 is attached to a side of the frame 1, as indicated by a dash-dot arrow ζ in FIG. 1. The electrical circuitry section 7 is electrically coupled with the aforementioned various component elements, so as to control the operation of the entire cylindrical outer surface scanning apparatus while exchanging signals with the respective component elements.

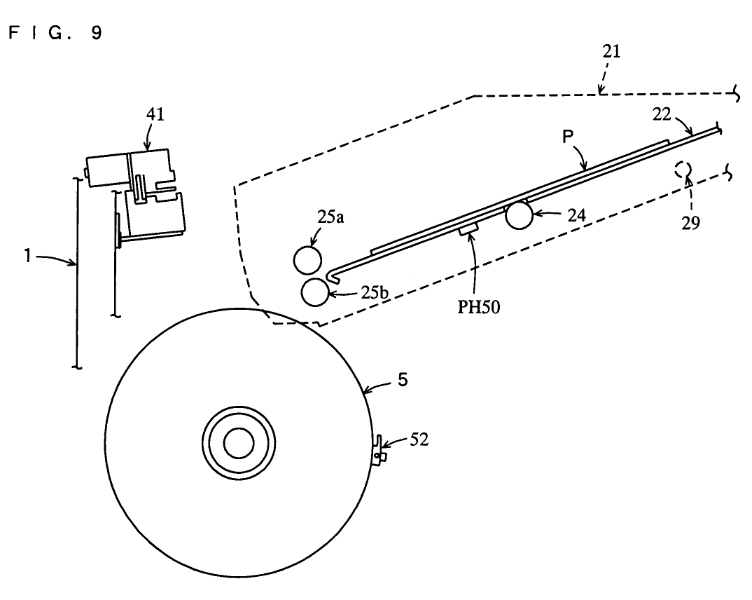

Next, the operation of the storage/transportation mechanism 2 and the plate P will be described with reference to FIGS. 9 to 16, which are schematic side views illustrating the operation of the storage/transportation mechanism 2 and the plate P.

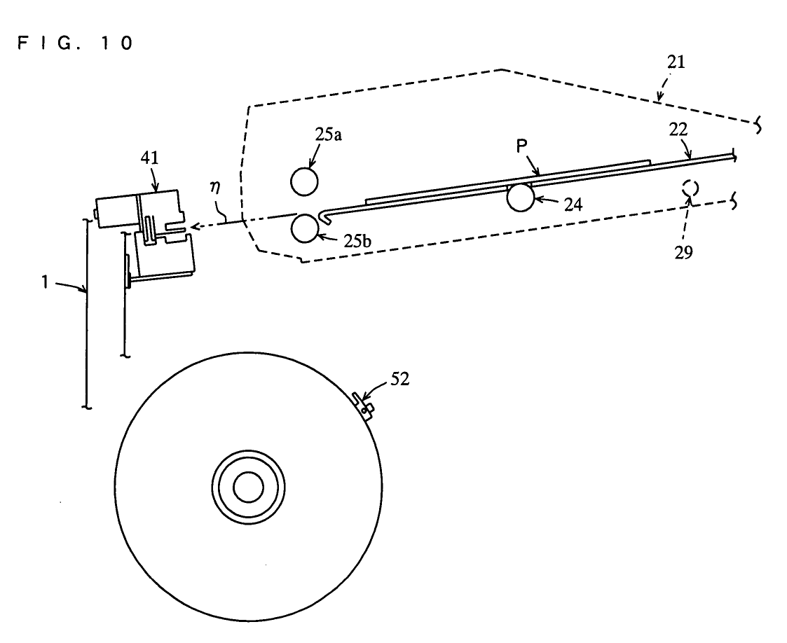

First, as shown in FIG. 9, a plate P to be punched is fed to the lower tray 22 of the storage/transportation mechanism 2. The plate P may be manually fed to the lower tray 22 by a human operator, or automatically fed by an automatic plate supplying mechanism (not shown) which may be additionally incorporated in the cylindrical outer surface scanning apparatus. Upon detecting that the plate P has been fed, the sensor PH50 of the storage/transportation mechanism 2 outputs a detection signal indicating the detection of the plate P to the electrical circuitry section 7. Upon receiving the detection signal, the electrical circuitry section 7 drives the respective motors M55 in order to begin a punching process for the plate P which is currently accommodated in the lower tray 22. Due to the driving force generated by the motors M55, the drive mechanism 3 moves the storage/transportation mechanism 2 from the lower position to the upper position. Consequently, as shown in FIG. 10, the transportation rollers 25 and the lower tray 22 of the storage/transportation mechanism 2 and the inlets 45 of the punch unit 4 are positioned substantially along a single line, with a first supply path line as shown by a dash-double dot arrow η being created therebetween. Note that the transportation roller 25a is disposed over the transportation roller 25b by means of a transportation roller up/down drive (not shown), so as not to be in contact with the transportation roller 25b.

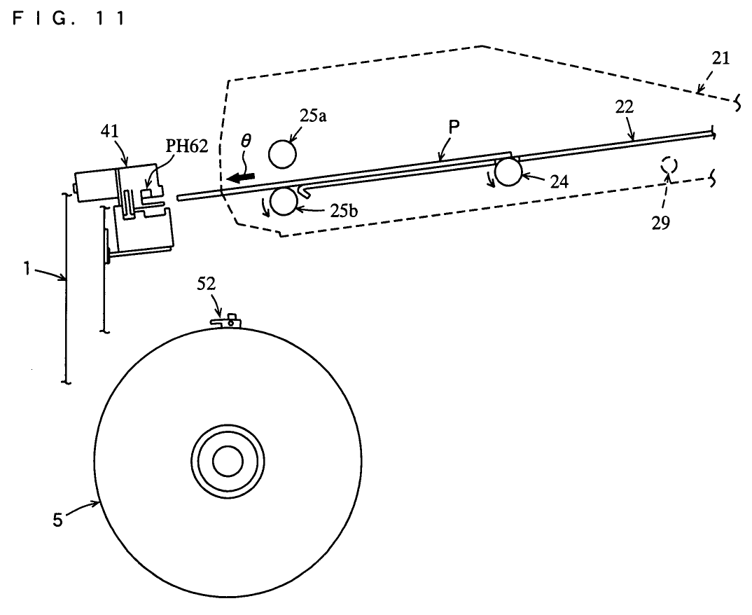

After the first supply path line is established, the electrical circuitry section 7 drives the motor M50. As shown in FIG. 11, the feed roller 24 and the transportation roller 25b rotate in a direction (see arrow θ) for feeding the plate P from the storage/transportation mechanism 2 to the punch unit 4 by the driving force generated by the motor M50. Hereinafter, such rotations of the feed roller 24 and the transportation roller 25b will be referred to as “forward rotations”. Thus, the plate P is sent across the lower tray 22 in the direction of the transportation rollers 25 based on the rotation of the feed roller 24, and then sent onto the first supply path line, the leading end first, by the action of the transportation roller 25b. The plate P which has thus been sent along is transported along the first supply path line in a linear trajectory, and at some point along the first supply path line, fine-positioned with respect to the respective punchers 41 by the above-described centering mechanism. The plate P thus fine-positioned is eventually led into the inlets 45 of the respective punchers 41.

When the sensor PH62 of each puncher 41 detects the leading end of the plate P having arrived immediately under itself, the sensor PH62 outputs a detection signal indicating the detection to the electrical circuitry section 7. In response to the detection signal, the electrical circuitry section 7 stops driving the motor M50. As described above, the plate P is fine-positioned with respect to the right-left direction by the centering mechanism, and fine-positioned with respect to the front-back direction based on the detection result by the sensor PH62. As a result, the punch unit 4 can form positioning notches or non-contacting notches at precise positions in the plate P.

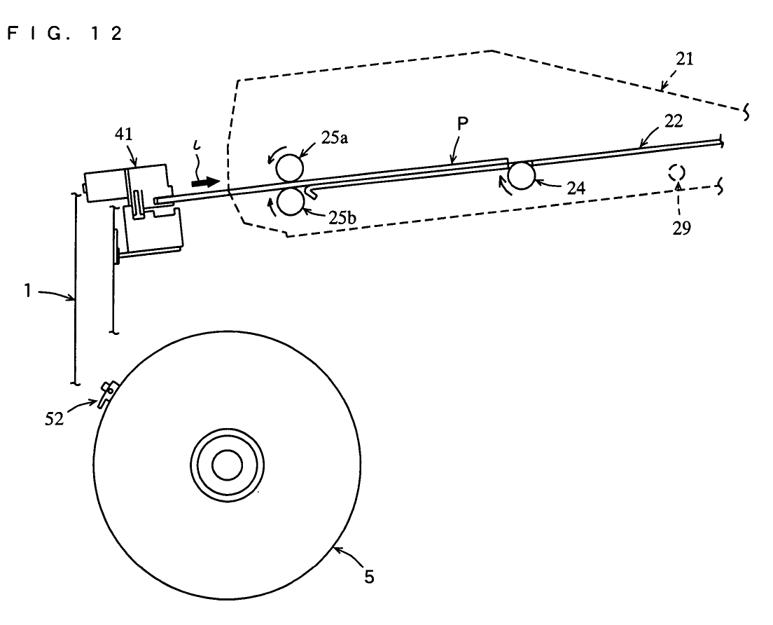

After the completion of the punching, the electrical circuitry section 7 drives the motor M50. At this time, the transportation roller 25a is moved down by the transportation roller up/down drive so as to be in an abutting relationship with the transportation roller 25b. As shown in FIG. 12, the feed roller 24 and the transportation rollers 25 rotate at a generally constant speed, in the direction of pulling the punched plate P out of the punch unit 4 back into the storage/transportation mechanism 2 (see arrow ι), due to the driving force generated by the motor M50. Hereinafter, such rotations of the feed roller 24 and the transportation rollers 25 will be referred to as “reverse rotations”. Due to such reverse rotations, the punched plate P is again accommodated into the lower tray 22 while traveling backwards along the first supply path line.

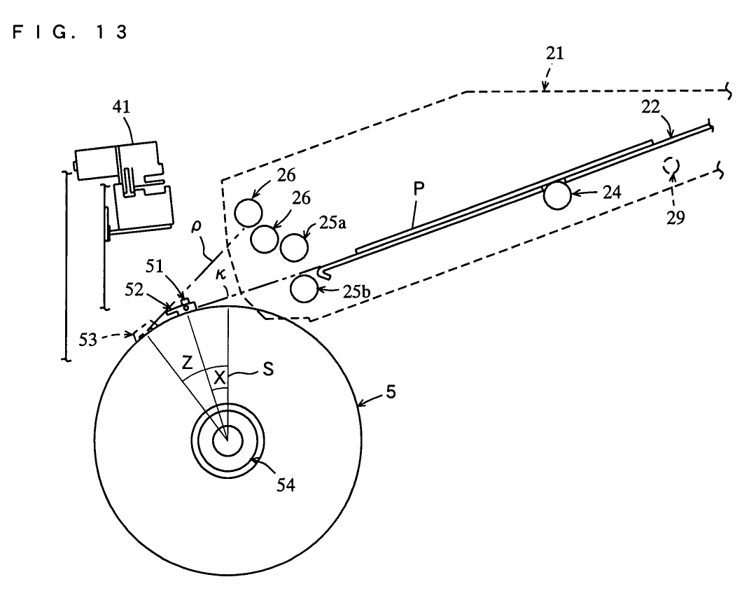

Next, the electrical circuitry section 7 stops driving the motor M50. The transportation roller up/down drive moves the transportation roller 25a up so as to be in a non-abutting relationship with the transportation roller 25b. Then, the electrical circuitry section 7 drives the respective motors M55. As shown in FIG. 13, the drive mechanism 3 causes the storage/transportation mechanism 2 to move from the upper position to the lower position due to the driving force generated by the respective motors M55, and the storage/transportation mechanism 2 is halted at the lower position. As a result, the storage/transportation mechanism 2 and the recording drum 5 are positioned so as to face each other. Then, a loading of the plate P which is currently accommodated in the lower tray 22 is performed.

The electrical circuitry section 7 drives the motor M1 to move the recording drum 5 to a position at which the leading-end clamp 52 takes the angular position X, where the recording drum 5 is halted. When the leading-end clamp 52 takes the angular position X, the storage/transportation mechanism 2 in its lower position and the recording drum 5 are of such a positional relationship that an imaginary line extending in line with the transportation rollers 25 is in contact with (or intersecting) the outer surface of the recording drum 5. Thus, the point of contact (or intersection) between the aforementioned imaginary line and the outer surface of the recording drum 5 defines the angular position X. Furthermore, a line segment κ connecting the transportation rollers 25 and the leading-end clamp 52 at the angular position X defines the second supply path line.

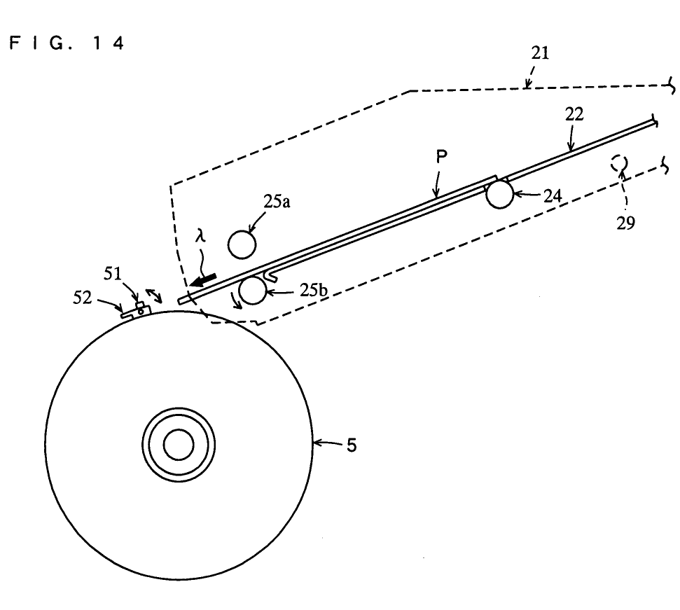

Then, the electrical circuitry section 7 drives the motor M50 to effect forward rotations of the feed roller 24 and the transportation rollers 25 as described above. Thus, as shown in FIG. 14, the plate P is sent off the lower tray 22 toward the recording drum 5, along the second supply path line (see arrow λ). The plate P thus sent-off is positioned with respect to the recording drum 5 as a positioning notch formed in the leading end of the plate P fits with the positioning pin 51.

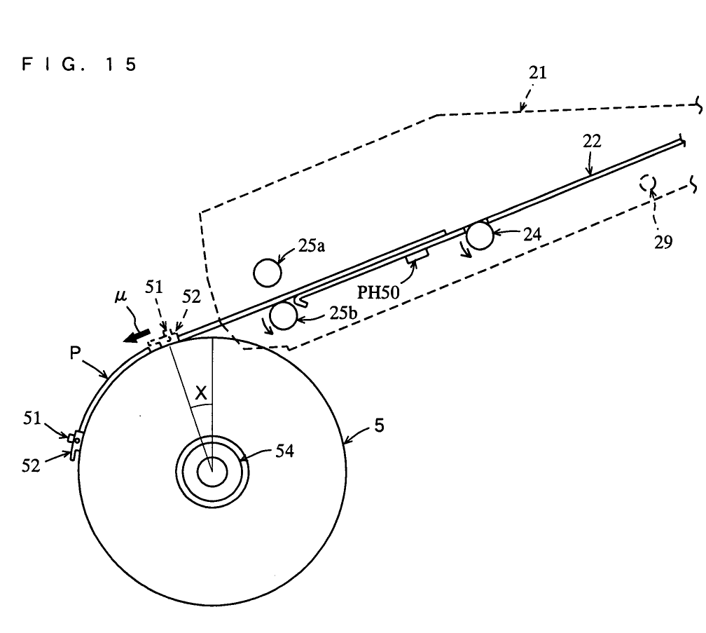

Once the leading end of the plate P is positioned with respect to the recording drum 5, the electrical circuitry section 7 drives the first clamp driving section so as to cause the leading-end clamp 52 to clamp the leading end of the plate P. Thereafter, the electrical circuitry section 7 runs the motor M1 to rotate the recording drum 5 in the direction indicated by arrow μ in FIG. 15, i.e., so that the plate P can be wound around the outer surface of the recording drum 5. Hereinafter, the rotation of the recording drum 5 in the direction of arrow μ will be referred to as its “forward rotation”.

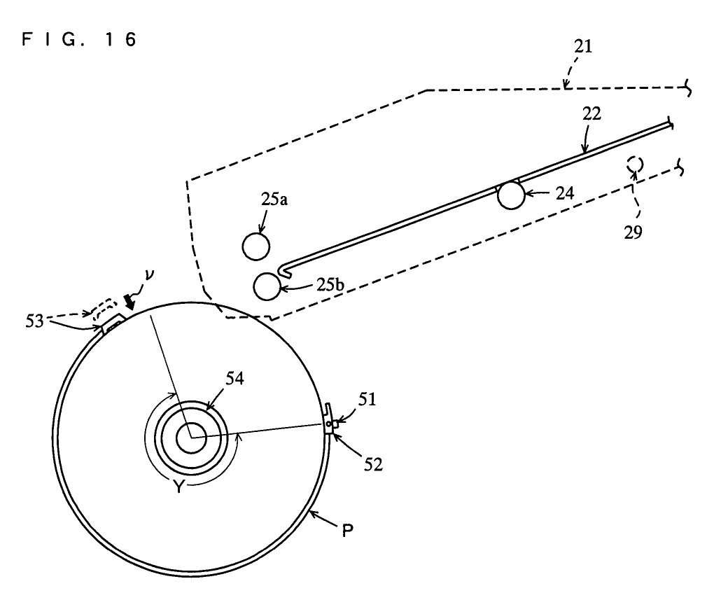

Consequently, as shown in FIG. 16, the plate P is wound around the outer surface of the recording drum 5 as it is removed from the lower tray 22. While the plate P is being wound around the outer surface of the recording drum 5, the plate P is pressed against the outer surface of the recording drum 5 by the action of the squeeze roller, and achieves close contact with the outer surface of the recording drum 5 through a vacuum suction realized by the aforementioned vacuum system. Finally, the plate P is completely removed from the lower tray 22 due to the rotation of the transportation rollers 25 and the recording drum 5, and is wound around the outer surface of the recording drum 5 while being closely pressed against the outer surface of the recording drum 5. As shown in FIG. 16, once the leading-end clamp 52 moves in a circular motion from the first angular position X by an angle Y, the other end (i.e., the trailing end) of the plate P arrives immediately under the trailing-end clamp 53, which is currently retained by the third clamp driving section (i.e., in the second angular position Z). The angular position Z and the angle Y are adjusted based on a signal outputted from a trailing-end sensor which detects the position of the trailing end of the plate P to be wound around the recording drum 5. The angular position Z and the angle Y will be described in detail below.

Then, the electrical circuitry section 7 stops driving the motor M1 at the angle Y. As a result, the other end (i.e., the trailing end) of the plate P is halted immediately under the retained trailing-end clamp 53 (i.e., at the angular position Z). Thereafter, as the electrical circuitry section 7 begins driving the third clamp driving section, as indicated by arrow ν in FIG. 16, the respective trailing-end clamps 53 are attached on the outer surface of the recording drum 5. Thus, the respective trailing-end clamps 53 clamp the trailing end of the plate P, thereby stabilizing the trailing end on the outer surface of the recording drum 5. The operation for attaching the trailing-end clamp 53 will be described below in detail. In this manner, the plate P is led into the punch unit 4 by the storage/transportation mechanism 2, and after being punched in accurate positions, led onto the recording drum 5 so as to be mounted in a specific position. Note that a sequence for mounting the plate P on the recording drum 5 will be described below in detail.

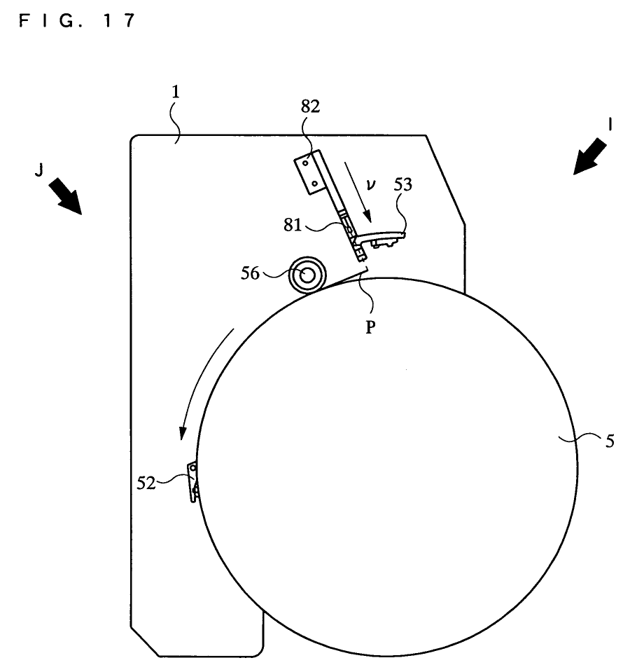

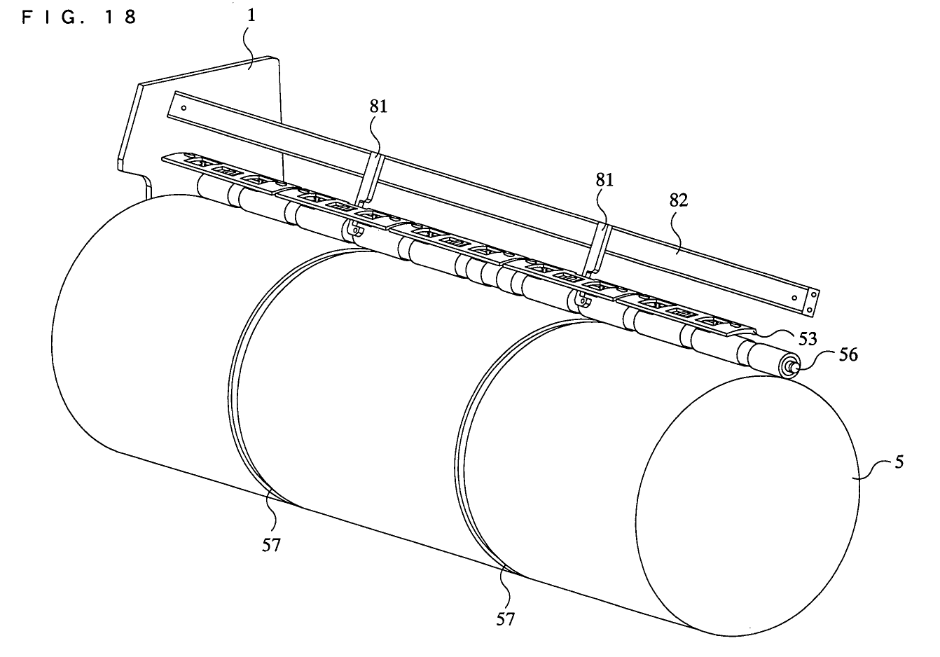

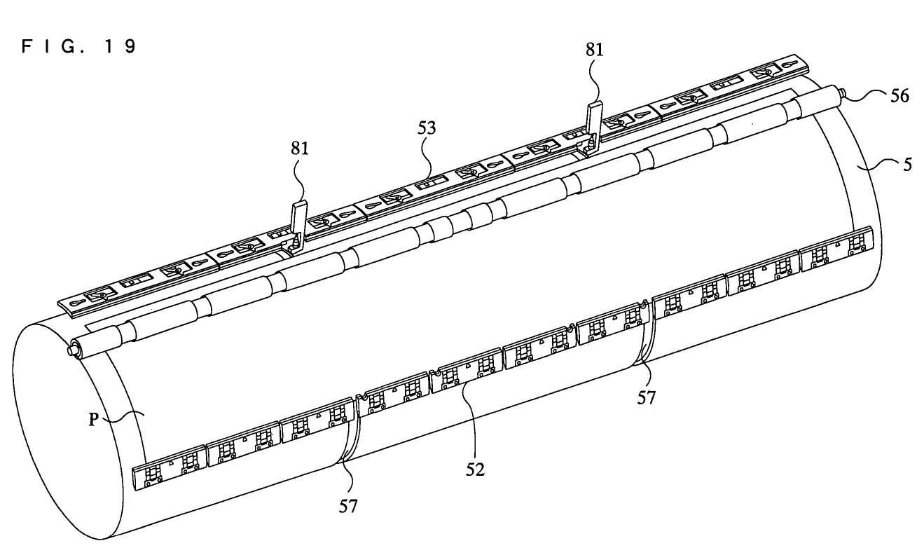

Next, referring to FIGS. 17 to 19, the trailing-end clamp 53, the squeeze roller 56, and a trailing-end sensor 81 provided in the cylindrical outer surface scanning apparatus will be described. FIG. 17 is a schematic side view illustrating a positional relationship of the recording drum 5, the trailing-end clamp 53, the squeeze roller 56, and the trailing-end sensor 81 as seen in the direction of arrow H in FIG. 1. FIG. 18 is a perspective view illustrating a positional relationship of the recording drum 5, the trailing-end clamp 53, the squeeze roller 56, and the trailing-end sensor 81 as seen in the direction of arrow in FIG. 17. FIG. 19 is a perspective view illustrating a positional relationship of the recording drum 5, the trailing-end clamp 53, the squeeze roller 56, and the trailing-end sensor 81 as seen in the direction of arrow J in FIG. 17. For clarity, the third clamp driving section is not shown in FIGS. 17 to 19.

Referring to FIGS. 17 to 19, the trailing-end clamp 53 is configured so as to be releasable from the outer surface of the recording drum 5. While the trailing-end clamp 53 is released from the recording drum 5, the trailing-end clamp 53 is retained by the third clamp driving section (not shown). Once attached on the outer surface of the recording drum 5 in the direction of arrow ν, the trailing-end clamp 53 functions to clamp the other end (i.e., the trailing end) of the plate P which comes transported along the above-described second supply path line. As shown in FIG. 17, an imaginary line extending in line with the direction of arrow ν is tilted toward the plate P so as to form an acute angle with respect to the normal of the outer surface of the recording drum 5. The trailing-end clamp 53 is attached on the recording drum 5 so as to function to clamp the trailing end of the plate P in the direction of pulling the plate P, thereby preventing the plate P to be mounted on the outer surface of the recording drum 5 from becoming wrinkled. Once attached on the recording drum 5, the trailing-end clamp 53 is released from the third clamp driving section, and stabilized on the recording drum 5. The squeeze roller 56 is configured so as to be in contact with the outer surface of the recording drum 5 as well as be releasable therefrom. While the plate P is being wound around the recording drum 5, the plate P is pressed against the cylindrical outer surface of the recording drum 5 by being interposed between the squeeze roller 56 and the recording drum 5.

The trailing-end sensor 81 is provided in the neighborhood of the trailing-end clamp 53 retained by the third clamp driving section. The trailing-end sensor 81 is fixed on a sensor fixing frame 82 which is provided within the frame 1 in parallel with the recording drum 5. The trailing-end sensor 81, which comprises an optical sensor or an ultrasonic sensor, detects whether or not a plate P is located at its sensing point. In order to improve the detection power of the trailing-end sensor 81, a groove 57 for detection purposes is formed on the cylindrical outer surface of the recording drum 5 along the circumference of the recording drum 5. The groove 57 is formed immediately under the trailing-end sensor 81. As shown in FIG. 17, for instance, a sensing point of the trailing-end sensor 81 is set to a trailing-end position of the plate P such that the trailing end of the plate P is clamped by the trailing-end clamp 53 with a desired gripper margin. In this case, it is possible to clamp the plate P with a desired gripper margin by clamping the trailing end of the plate P by means of the trailing-end clamp 53 at a position where the trailing-end sensor 81 detects the trailing end of the plate P (i.e., a position where the plate P is terminated). The sensing point of the trailing-end sensor 81 may be located in a different position, e.g., a position in the neighborhood of the squeeze roller 56, where the plate P is stabilized on the outer surface of the recording drum 5 in close contact thereto. In this case, the trailing end of the plate P is clamped by the trailing-end clamp 53 after the recording drum 5 is rotated backward (i.e., clockwise rotations in FIG. 17; herein after referred to as “reverse rotations”) by a predetermined angle from the position where the trailing-end sensor 81 detects the trailing end of the plate P, whereby it is possible to clamp the plate P with a desired gripper margin. In the present embodiment, two trailing-end sensors 81 are provided so as to also detect a tilt of the trailing end of the plate P with respect to the cylindrical axis of the recording drum 5, and two grooves 57 corresponding to the respective trailing-end sensors 81 are formed on the outer surface of the recording drum 5.

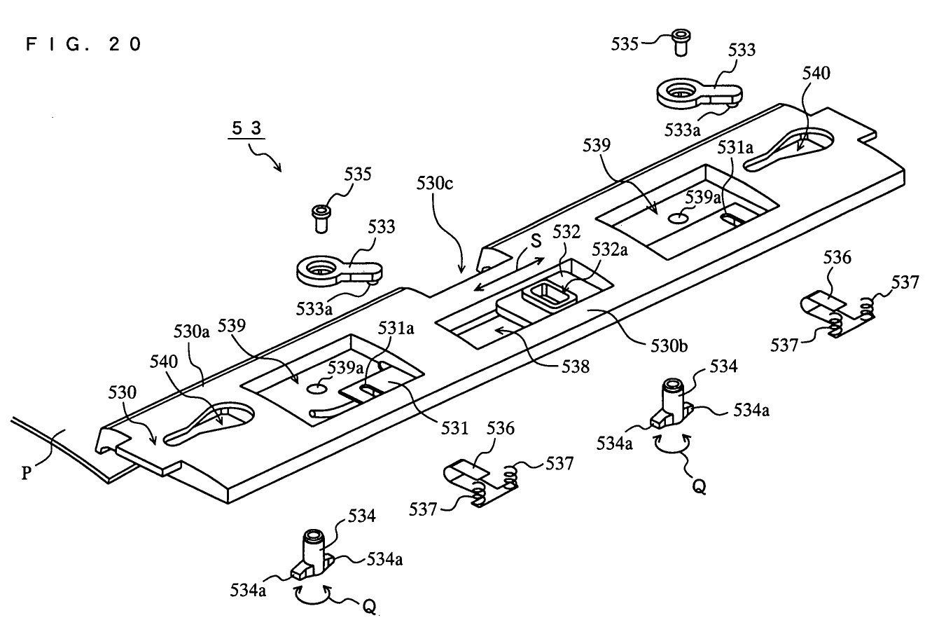

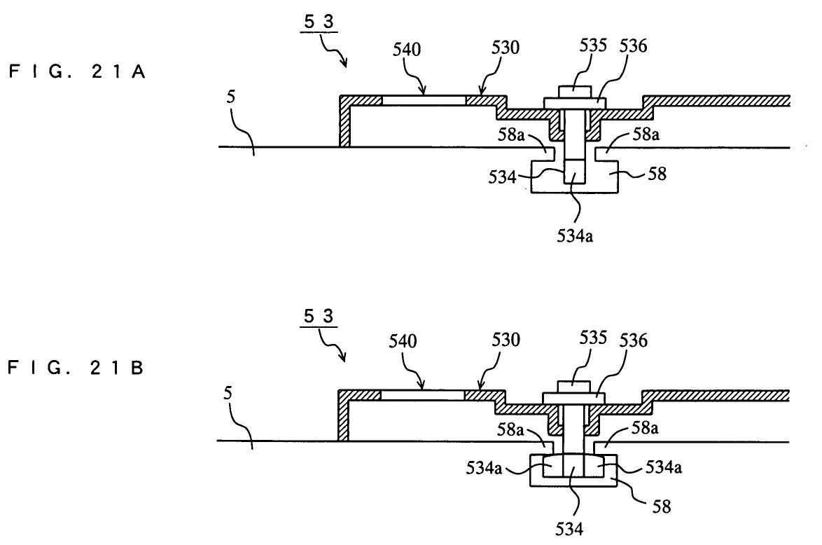

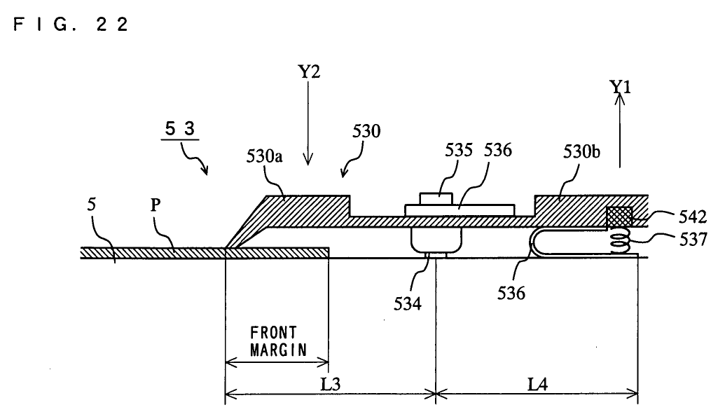

Next, referring to FIGS. 20 to 22, the structure of the trailing-end clamp 53 will be described. FIG. 20 is an exploded perspective view of the trailing-end clamp 53. FIGS. 21A and 21B are longitudinal cross-sectional views of a portion of the trailing-end clamp 53. FIG. 22 is a horizontal cross-sectional view of the trailing-end clamp 53.

As shown in FIGS. 20 to 22, the trailing-end clamp 53 comprises a clamp main body 530, a clamp bolt connecting plate 531, an engaging member 532, two first clamp bolts 533, two second clamp bolts 534, two screws 535, two leaf springs 536, and four springs 537.

A rectangular recess section 538 is formed at the center of the clamp main body 53, and rectangular recess sections 539 are formed on both sides of the recess section 538. A through hole 539a is formed on the bottom of each recess section 539. A retaining hole 540 is provided in the neighborhood of each end of the clamp main body 530. The retaining hole 540 comprises a circular portion and a bottle-neck shaped portion. Retaining pins 976 of the third clamp driving section 9 (described below) are inserted in the corresponding retaining holes 540. Assume that the clamp main body 530 comprises two portions: one end portion 530a and other end portion 530b. As will be apparent from the description to follow, a portion near the trailing end of the plate P is pinched between the lower surface of the one end portion 530a and the outer surface of the recording drum 5. In the case where the sensing point of the trailing-end sensor 81 is set in the neighborhood of the one end portion 530a, a window 530c for trailing-end detection purposes is formed in the one end portion 530a of the clamp main body 530.

The clamp bolt connecting plate 531 penetrates the sides of the recess sections 538 and 539 so as to slidably move in the direction of arrow S shown in FIG. 20 through the recess section 538 and the two recess sections 539. The engaging member 532 is fixed on the clamp bolt connecting plate 531 in the recess section 538. The engaging member 532 has an engaging hole 532a formed thereon. A driving pin of the third clamp driving section 9 is engaged in the engaging hole 532a. In the neighborhood of each end of the clamp bolt connecting plate 531, a long hole 531a is formed.

Protruding sections 534a, each protruding in the lateral direction, are provided on the outer surface of the second clamp bolt 534. The second clamp bolt 534 penetrates the through hole 539a such that the protruding sections 534a are located under the clamp main body 530. The first clamp bolt 533 is fixedly attached to the head of the second clamp bolt 534 by means of the screw 535. A protrusion 533a is provided on the lower surface of the first clamp bolt 533. The protrusion 533a of the first clamp bolt 533 is engaged in the long hole 531a of the clamp bolt connecting plate 531. When the third clamp driving section 9 slides the engaging member 532 in the direction of arrow S, with the driving pin thereof being engaged in the engaging hole 532a, the clamp bolt connecting plate 531 slides in the direction of arrow S in conjunction with the engaging member 532. Consequently, the first clamp bolt 533 rotates in the direction of arrow Q shown in FIG. 20 in conjunction with the second clamp bolt 534.

As shown in FIGS. 21A and 21B, a clamp groove 58 is formed on the outer surface of the recording drum 5 in a spaced manner in the circumferential direction. Note that the suction groove 55 (see FIG. 7) may double as the clamp groove 58. Edge portions 58a protrude inwardly from the upper ends (near the cylindrical outer surface) of both sides of the clamp groove 58 formed on the recording drum 5. As shown in FIG. 21A, in the case where the protruding sections 534a of the second clamp bolt 534 are located in parallel with the clamp groove 58, the protruding sections 534a are not engaged with the edge portions 58a of the clamp groove 58. In this case, the trailing-end clamp 53 can be taken off the recording drum 5. On the other hand, as shown in FIG. 21B, in the case where the protruding sections 534a of the second clamp bolt 534 are located in the clamp groove 58 perpendicularly thereto, the protruding sections 534a are engaged with the edge portions 58a of the clamp groove 58. Thus, the trailing-end clamp 53 is stabilized on the outer surface of the recording drum 5. As described above, the third clamp driving section 9 is capable of rotating the second clamp bolt 534. Such rotations allow the trailing-end clamp 53 to be stabilized on/taken off the outer surface of the recording drum 5.

As shown in FIG. 22, a portion near the trailing end of the plate P is pinched between the lower surface of the one end portion 530a and the outer surface of the recording drum 5. The length from the tip of the one end portion 530a of the clamp main body 530 to the trailing end of the plate P having been clamped by the trailing-end clamp 53 corresponds to the “gripper margin”. A lead plate 542 is embedded in the lower part of the other end portion 530b of the clamp main body 530. The leaf spring 536 and the spring 537 are provided under the other end portion 530b of the clamp main body 530.

In the case where the trailing-end clamp 53 is stabilized on the recording drum 5, the other end portion 530b of the clamp main body 530 is biased so as to get away from the recording drum 5, as indicated by arrow Y1 in FIG. 22, due to a reactive force of the leaf spring 536 and the spring 537 while being fixed by the second clamp bolt 534. Due to the above-described reactive force, a force acting on the one end portion 530a of the clamp main body 530 to move it closer to the recording drum 5, as indicated by arrow Y2, is applied to the one end portion 530a. Consequently, a portion near the trailing end of the plate P on the recording drum 5 is pressed by the lower surface of the one end portion 530a of the clamp main body 530. Note that the length L3 from the second clamp bolt 534 to the one end portion 530a of the clamp main body 530 is set so as to be shorter than the length L4 from the second clamp bolt 534 to the other end portion 530b of the clamp main body 530.

When the recording drum 5 rotates, a centrifugal force in the direction of arrow Y1 acts on the lead plate 542 embedded in the lower surface of the other end portion 530b of the clamp main body 530. A centrifugal force also acts on the one end portion 530a and the other end portion 530b of the clamp main body 530. As described above, the length L3 of the one end portion 530a of the clamp main body 530 is set so as to be shorter than the length L4 of the other end portion 530b of the clamp main body 530. Thus, the rotation moment of the one end portion 530a of the clamp main body 530 with respect to the second clamp bolt 534 is smaller than the rotation moment of the other end portion 530b. As a result, by the action of a force detaching the other end portion 530b of the clamp main body 530 from the outer surface of the recording drum 5, a portion near the trailing end of the plate P is pressed tightly against the outer surface of the recording drum 5 by the one end portion 530a of the clamp main body 530. The faster the recording drum 5 rotates, the greater the force acting on the other end portion 530b of the clamp main body 530, i.e., the greater the force with which the one end portion 530a of the clamp main body 530 presses a portion near the trailing end of the plate P against the outer surface of the recording drum 5. As a result, even in the case where the recording drum 5 is rotating at a high speed, a portion near the trailing end of the plate P is stabilized steadily on the outer surface of the recording drum 5 without being misaligned or detached therefrom.

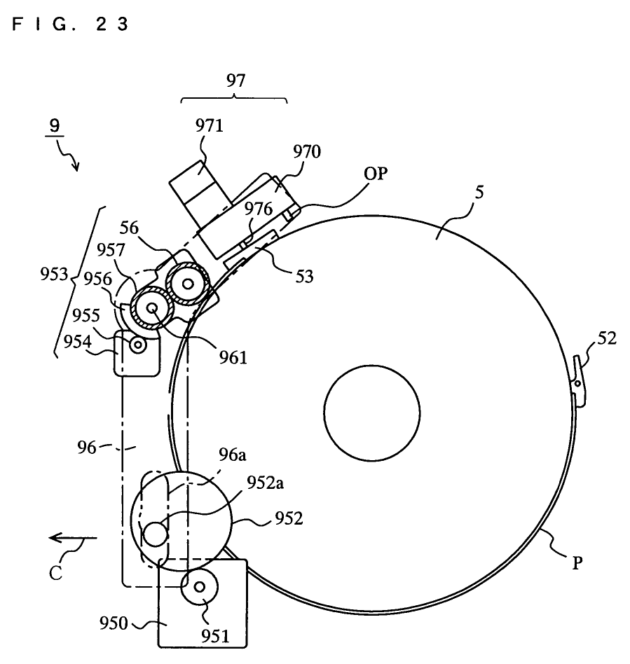

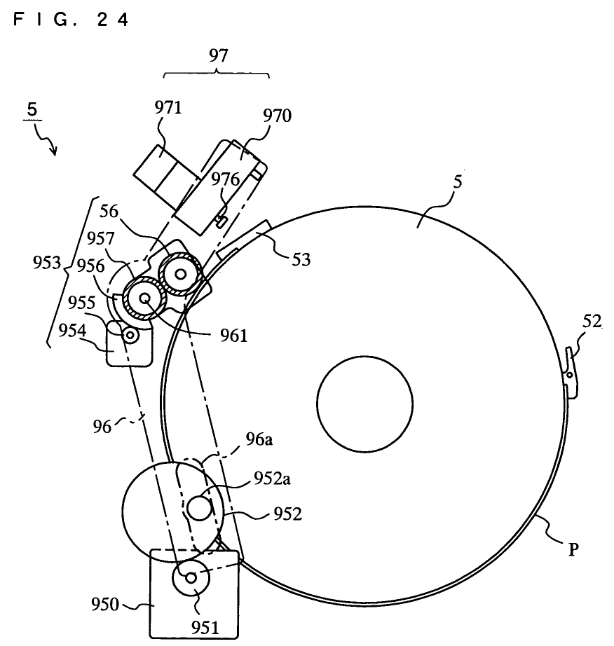

Next, referring to FIGS. 23 and 24, a structure of the third clamp driving section 9 will be described. FIG. 23 is a side view illustrating how the trailing-end clamp 53 is attached to the recording drum 5 by the third clamp driving section 9.

FIG. 24 is a side view illustrating how the trailing-end clamp 53 is separated from the third clamp driving section 9 after being stabilized on the recording drum 5.

In FIG. 23, the third clamp driving section 9 has a clamp arm driving motor 950. A gear 951 is attached to a driving axis of the clamp arm driving motor 950. The gear 951 is engaged with a gear 952, and an engaging section 952a provided on the gear 952 is engaged in a long hole 96a formed on a clamp arm 96. When the clamp arm driving motor 950 rotates, the clamp arm 96 oscillates about a rotation axis 961 in the direction of arrow C.

A squeeze apparatus 953 is provided in the third clamp driving section 9. The squeeze apparatus 953 comprises a squeeze driving motor 954, a gear 955, an oscillating member 956, an adhesive roller 957, and a squeeze roller 56. The gear 955 is attached to a driving axis of the squeeze driving motor 954. The gear 955 is disposed in such a manner that the gear 955 is engaged with one end of the oscillating member 956. A rotation axis of the squeeze roller 56 is attached to the oscillating member 956. When the squeeze driving motor 954 rotates, the oscillating member 956 oscillates via the gear 955, such that the outer surface of the squeeze roller 56 is in contact with the outer surface of the recording drum 5 (see FIG. 23). In this situation, the outer surface of the squeeze roller 56 also touches the adhesive roller 957. Due to the rotation of the recording drum 5, dirt and dust are transferred from the surface of the plate P to the outer surface of the squeeze roller 56, and then the dirt and dust transferred to the squeeze roller 56 are transferred to the adhesive roller 957.

A clamp drive unit 97 is provided in the third clamp driving section 9. The clamp drive unit 97 comprises a drive main body 970, a clamp bolt driving motor 971, a retaining pin 976, and a driving pin (not shown). The drive main body 970 is fixed in the neighborhood of the tip portion of the clamp arm 96. The retaining pin 976 and the driving pin are attached to the lower surface of the drive main body 970. The clamp bolt driving motor 971 is fixed on the drive main body 970. A predetermined gear mechanism is attached to the clamp bolt driving motor 971 so as to slide the driving pin, which is engaged in the engaging hole 532a (see FIG. 20) of the engaging member 532, in the direction of the slide of the engaging member 532 by the rotation of the clamp bolt driving motor 971. Due to the rotation of the clamp bolt driving motor 971, the gear mechanism also slides the retaining pin 976, which is engaged in the retaining hole 540 of the clamp main body 530, in the same direction, i.e., the direction of the slide of the engaging member 532.

When the third clamp driving section 9 retains the trailing-end clamp 53, the retaining pin 976 is inserted in the bottle-neck shaped portion of the retaining hole 540 of the trailing-end clamp 53, whereas the driving pin is disposed in a position where the protruding sections 534a are in parallel with the clamp groove 58. In this situation, by oscillating the tip portion of the clamp arm 96 toward the recording drum 5, it is possible to insert the second clamp bolt 534 in the clamp groove 58 of the recording drum 5 while retaining the trailing-end clamp 53 by means of the third clamp driving section 9 (see FIG. 21A).

When the clamp bolt driving motor 971 rotates, the driving pin slides, and the engaging member 532 engaged with the driving pin also slides in the direction of arrow S along with the clamp bolt connecting plate 531. As a result, the first clamp bolt 533 rotates in conjunction with the second clamp bolt 534. Consequently, the protruding sections 534a of the second clamp bolt 534 become perpendicular to the clamp groove 58 of the recording drum 5, and the trailing-end clamp 53 is fixed to the clamp groove 58 of the recording drum 5. On the other hand, when the clamp bolt driving motor 971 rotates, the retaining pin 976 also slides to the circular portion of the retaining hole 540 of the trailing-end clamp 53. Thus, as shown in FIG. 21B, the trailing-end clamp 53 is fixed to the clamp groove 58 of the recording drum 5, whereas it can be taken off the third clamp driving section 9 by oscillating the tip portion of the clamp arm 96 so as to get away from the recording drum 5 (see FIG. 24). By performing the above operation the other way around, it is possible to take the trailing-end clamp 53 off the recording drum 5, and retain the trailing-end clamp 53 by means of the third clamp driving section 9. Note that various other component elements are provided in the third clamp driving section 9. For conciseness, any detailed description thereof will be omitted.

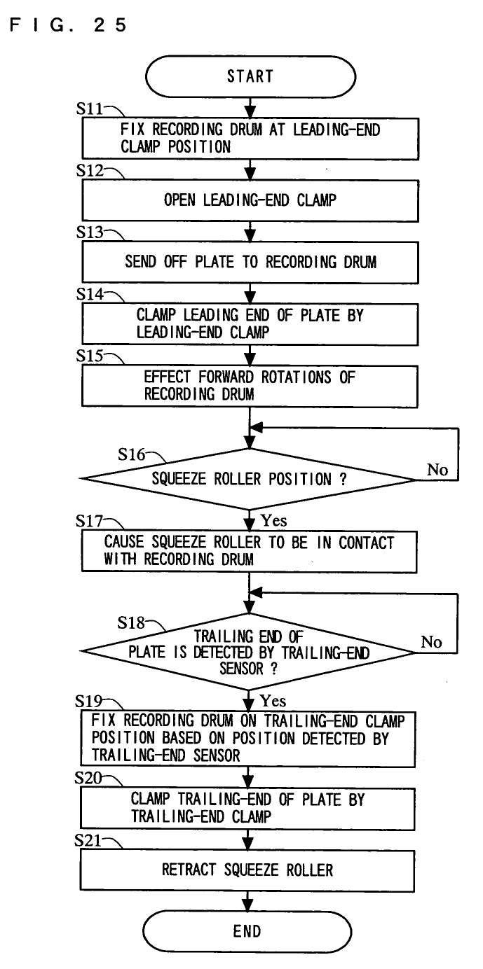

Next, referring to FIGS. 25 to 29, a detailed sequence for mounting the plate P on the recording drum 5 will be described.

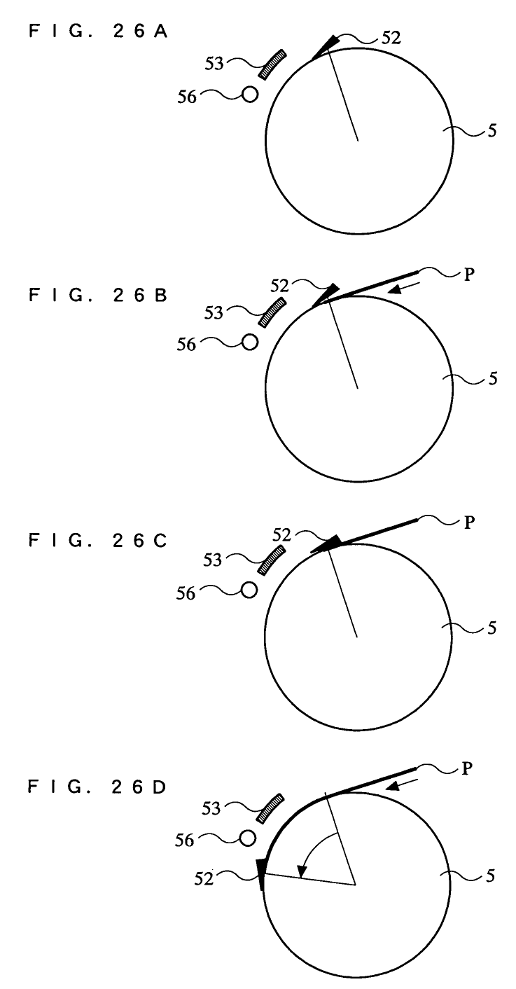

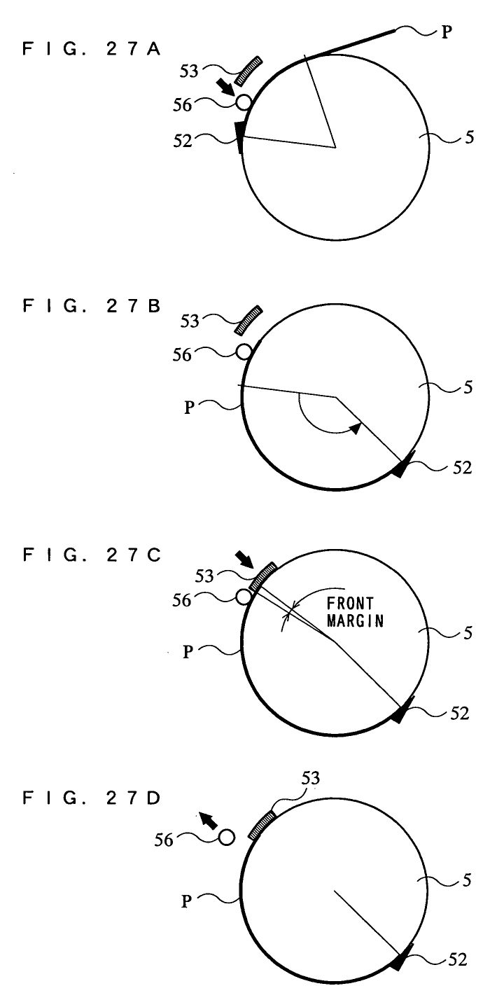

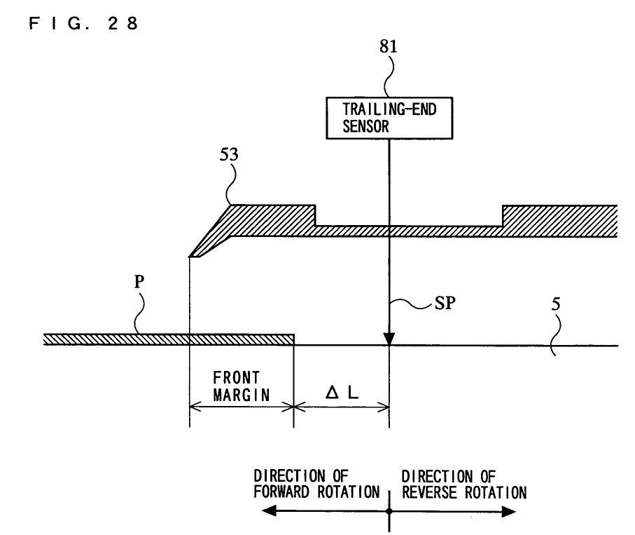

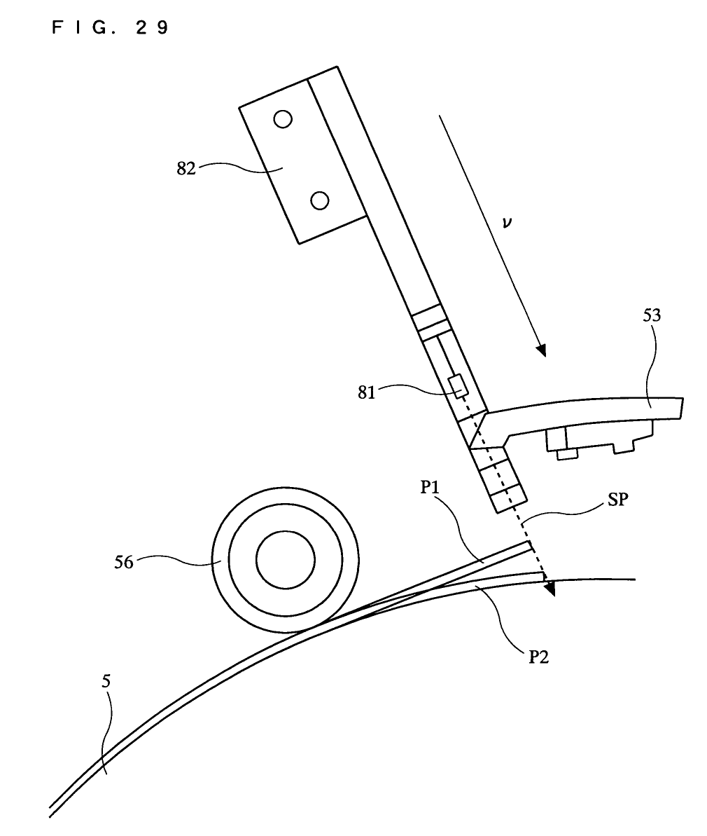

FIG. 25 is a flowchart illustrating a sequence for mounting the plate P on the recording drum 5. FIGS. 26A to 26D are schematic diagrams illustrating the first half of the operation for mounting the plate P on the recording drum 5. FIGS. 27A to 27D are schematic diagrams illustrating the last half of the operation for mounting the plate P on the recording drum 5. FIG. 28 is a schematic diagram illustrating a positional relationship of the trailing end position of the plate P, which is detected by the trailing-end sensor 81, and the trailing-end clamp position. FIG. 29 is a schematic diagram illustrating the trailing end of the plate P having being detected by the trailing-end sensor 81. For conciseness, in FIGS. 26A to 26D and FIGS. 27A to 27D, only a schematic side view of the recording drum 5, the leading-end clamp 52, the trailing-end clamp 53, the squeeze roller 56, and the plate P is shown.

In FIGS. 25 to 27, the electrical circuitry section 7 fixes a rotational angle position of the recording drum 5 at the leading-end clamp position (step S11; FIG. 26A). The leading-end clamp position corresponds to the above-described first angular position X (see FIG. 8), where the storage/transportation mechanism 2 in its lower position and the leading-end clamp 52 are of such a positional relationship that an imaginary line extending in line with the transportation rollers 25 is in contact with (or intersecting) the outer surface of the recording drum 5.

Next, the electrical circuitry section 7 opens the leading-end clamp 52 (step S12), and sends off the plate P from the storage/transportation mechanism 2 to the recording drum 5 (step S13; FIG. 26B). When the leading-end clamp 52 is opened, a space is formed between one end portion of the leading-end clamp 52, which lies closer to the storage/transportation mechanism 2 than the other end portion of the leading-end clamp 52, and the outer surface of the recording drum 5. Specifically, the clamp arm 96 is oscillated in such a manner that the other end portion of the leading-end clamp 52 is pressed by a releasing pin OP (see FIG. 23) fixed in the neighborhood of the tip portion of the clamp arm 96. When the pressing force of the releasing pin OP is greater than the biasing force with which the one end portion of the leading-end clamp 52 is pressed against the outer surface of the recording drum 5, a space is formed between the one end portion of the leading-end clamp 52 and the outer surface of the recording drum 5. The plate P is transported from the storage/transportation mechanism 2 with the leading-end clamp 52 being opened, and the leading end of the plate P is inserted in the space formed between the one end portion of the leading-end clamp 52 and the outer surface of the recording drum 5. The notch formed in the leading end of the plate P is engaged with the positioning pin 51, whereby the leading end of the plate P is positioned with respect to the recording drum 5.

Next, the electrical circuitry section 7 clamps the leading end of the plate P by the leading-end clamp 52 (step S14; FIG. 26C). Specifically, when the clamp arm 96 is oscillated so as to get away from the recording drum 5, the pressure by the releasing pin OP is released. As a result, the biasing force of the leading-end clamp 52 causes the one end portion of the leading-end clamp 52 to be pressed against the outer surface of the recording drum 5, whereby the leading end of the plate P is clamped between the one end portion of the leading-end clamp 52 and the outer surface of the recording drum 5.

Next, the electrical circuitry section 7 effects forward rotations (counterclockwise rotations in FIGS. 26A to 26D) of the recording drum 5 (step S15), and waits for the rotational angle position of the recording drum 5 to arrive the squeeze roller position (step S16; FIG. 26D). The squeeze roller position corresponds to a position where the leading-end clamp 52 arrives shortly after passing immediately under the squeeze roller 56, and the plate P wound around the recording drum 5 is situated immediately under the squeeze roller 56.

Next, when the rotational angle position of the recording drum 5 arrives the squeeze roller position, the electrical circuitry section 7 causes the roller surface of the squeeze roller 56 to be in contact with the recording drum 5 around which the plate P is wound (step S17; FIG. 27A). The electrical circuitry section 7 further effects forward rotations of the recording drum 5, and waits for the trailing-end sensor 81 to detect the trailing end of the plate P wound around the recording drum 5 (step S18). When the trailing-end sensor 81 detects the trailing end of the plate P, the electrical circuitry section 7 fixes the rotational angle position of the recording drum 5 at the trailing-end clamp position based on the trailing end position of the plate P, which is detected by the trailing-end sensor 81 (step S19; FIG. 27B) Hereinafter, referring to FIG. 28, a positional relationship of the trailing end position of the plate P, which is detected by the trailing-end sensor 81, and the trailing-end clamp position.

As is the case with FIG. 27B, FIG. 28 is a schematic side view of the recording drum 5, the trailing-end clamp 53, the trailing-end sensor 81, and the plate P, which are enlarged for description. As described above, the trailing-end sensor 81 detects whether or not the plate P is located at its sensing point SP. Thus, when the trailing-end sensor 81 detects the trailing end position of the plate P, the trailing end of the plate P is located at the sensing point SP. On the other hand, the trailing-end clamp position is located at the rotational angle position of the recording drum 5, where a desired gripper margin can be obtained when the trailing end of the plate P is clamped by the trailing-end clamp 53. In other words, when the trailing-end clamp 53 is mounted on the recording drum 5 fixed at the trailing-end clamp position, the trailing end of the plate P is clamped with a desired gripper margin.

Assume that the sensing point SP of the trailing-end sensor 81 is located at the trailing end position of the plate P where a desired gripper margin can be obtained (ΔL=0 in FIG. 28). In this case, the trailing end of the plate P is clamped with a desired gripper margin if the trailing-end clamp 53 is mounted on the recording drum 5 at the rotational angle position of the recording drum 5 at which the trailing end position of the plate P is detected by the trailing-end sensor 81. On the other hand, the sensing point SP of the trailing-end sensor 81 and the trailing end position of the plate P, where a desired gripper margin can be obtained, may be set at different positions (a difference therebetween=ΔL) in the circumferential direction of the recording drum 5. In this case, the trailing end point of the plate P is first detected by the trailing-end sensor 81, and the rotational angle position of the recording drum 5 is adjusted by the difference ΔL to obtain the trailing-end clamp position. In FIG. 28, the sensing point SP is located at a distance ΔL from the trailing end position of the plate P, where a desired gripper margin can be obtained, in the direction of reverse rotations. In this case, the electrical circuitry section 7 rotates the recording drum 5 by the difference ΔL in the direction of forward directions after the trailing end position of the plate P is detected by the trailing-end sensor 81, and fixes the recording drum 5 at the trailing-end clamp position. In the case where the sensing point SP is located at a distance ΔL from the trailing end position of the plate P, where a desired gripper margin can be obtained, in the direction of forward rotations, the electrical circuitry section 7 rotates the recording drum 5 by the difference ΔL in the direction of reverse directions after the trailing end point of the plate P is detected by the trailing-end sensor 81, and fixes the recording drum 5 at the trailing-end clamp position.

As shown in FIGS. 18 and 19, a plurality of trailing-end sensors 81 may be provided. In this case, if the sensing point SP is located at some distance from the trailing end position of the plate P, where a desired gripper margin can be obtained, in the direction of reverse rotations, a position at which any of the plurality of trailing-end sensors 81 first detects the trailing end of the plate P is defined as the trailing end position of the plate at step S18. In the case where the sensing point SP is located at some distance from the trailing end position of the plate P, where a desired gripper margin can be obtained, in the direction of forward rotations, a position at which any of the plurality of trailing-end sensors 81 last detects the trailing end of the plate P is defined as the trailing end position of the plate at step S18. Alternatively, after all of the plurality of trailing-end sensors 81 detect the trailing ends of the plate P, an average of the detected trailing ends may be obtained as the trailing end position of the plate at step S18.

As shown in FIG. 29, since the trailing end of the plate P is detected by the trailing-end sensor 81, variations may occur due to a difference in rigidity (stiffness) of the plate P. To be more specific, the trailing end of a plate P1 with high stiffness is detected by the trailing-end sensor 81 while being suspended above the outer surface of the recording drum 5, whereas the trailing end of the plate P2 with low stiffness is detected by the trailing-end sensor 81 while being attached to the outer surface of the recording drum 5. The stiffness of the plate P depends on the material, thickness, and width of the plate P. Thus, the difference ΔL may be set according to a type of plate P in view of the above-described variations. In the case where an optical sensor is used as the trailing-end sensor 81, there may be a difference in the trailing end position detected by the trailing-end sensor 81 due to a difference in the reflectivity of the plate P. In this case, the difference ΔL may be set according to a type of plate P in view of variations in the detected position due to the difference in the reflectivity of the plate P. Specifically, the trailing end position of the plate P detected by the trailing-end sensor 81 is adjusted according to a type of plate P (e.g., stiffness and reflectivity) to set a position at which the plate P is clamped by the trailing-end clamp 53 with an adequate gripper margin (i.e., a position at which the trailing-end clamp 53 is mounted on the recording drum 5). Alternatively, in order to prevent the occurrence of variations due to a difference in the stiffness of the plate P, the sensing point SP may be set at a position in the neighborhood of the squeeze roller 56, for example, where the trailing end position of the plate P is stabilized.

Referring again to FIG. 25 and FIGS. 27A to 27D, after the operation at step S19, the electrical circuitry section 7 clamps the trailing end of the plate P with a desired gripper margin by using the trailing-end clamp 53 (step S20; FIG. 27C). The clamping operation by the trailing-end clamp 53 has already been described, and the detailed description thereof will be omitted.

Next, the electrical circuitry section 7 retracts the squeeze roller 56 to detach it from the recording drum 5 (step S21;

FIG. 27D). At this step, the operation for mounting the plate P on the recording drum 5 is ended. Thereafter, the exposure head 6 (see FIG. 1) performs an exposure process to record an image on the plate P mounted on the outer surface of the recording drum 5.

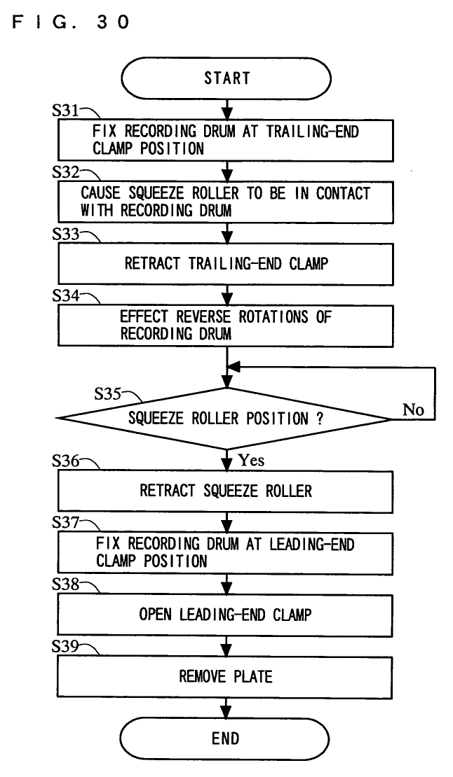

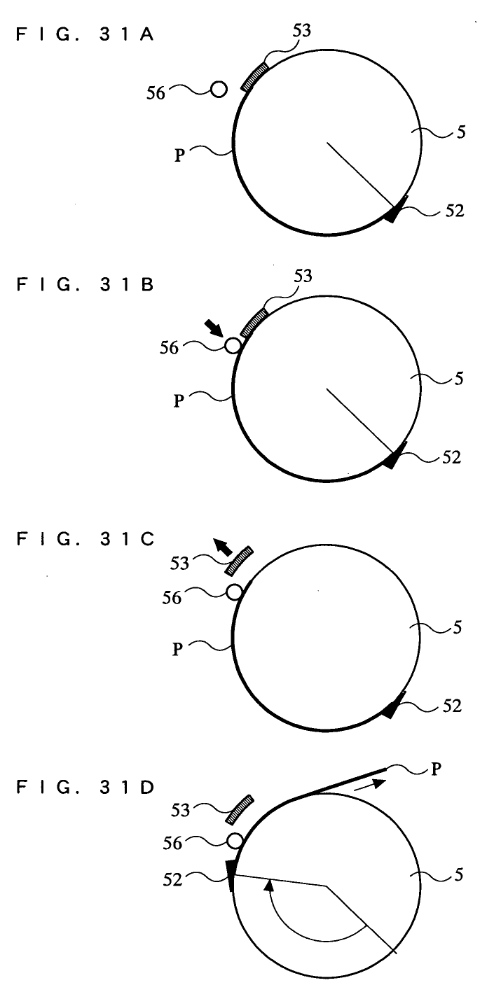

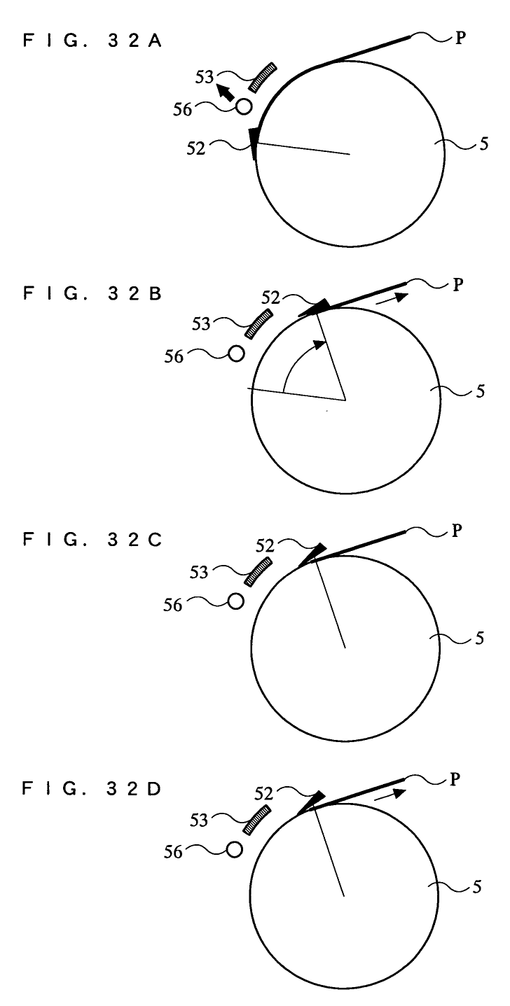

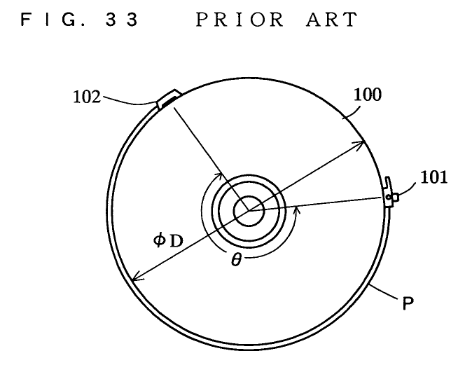

Next, referring to FIGS. 30 to 32, a detailed sequence for removing the plate P from the recording drum 5 will be described. FIG. 30 is a flowchart illustrating a sequence for removing the plate P from the recording drum 5. FIGS. 31A to 31D are schematic diagrams illustrating the first half of the operation for removing the plate P from the recording drum 5. FIGS. 32A to 32D are schematic diagrams illustrating the last half of the operation for removing the plate P from the recording drum 5. For conciseness, in FIGS. 31A to 31D and FIGS. 32A to 32D, only a schematic side view of the recording drum 5, the leading-end clamp 52, the trailing-end clamp 53, the squeeze roller 56, and the plate P is shown.

In FIGS. 30 to 32, the electrical circuitry section 7 fixes a rotational angle position of the recording drum 5 at the trailing-end clamp position (step S31; FIG. 31A). The trailing-end clamp position is identical to the rotational angle position of the recording drum 5 fixed at step S19. The electrical circuitry section 7 causes the roller surface of the squeeze roller 56 to be in contact with the recording drum 5 around which the plate P is wound (step S32; FIG. 31B).

Next, the electrical circuitry section 7 causes the third clamp driving section 9 to retract the trailing-end clamp 53 to detach it from the recording drum 5, and releases the clamping on the trailing end of the plate P (step S33; FIG. 31C). The retracting operation of the trailing-end clamp 53 has already been described, and the detailed description thereof will omitted.

Next, the electrical circuitry section 7 effects reverse rotations (clockwise rotations in FIGS. 31A to 31D) of the recording drum 5 (step S34), and waits for the rotational angle position of the recording drum 5 to arrive the squeeze roller position (step S35; FIG. 31D). The squeeze roller position is identical to a position described at step S16, i.e., a position where the leading-end clamp 52 arrives shortly after passing immediately under the squeeze roller 56, and the plate P wound around the recording drum 5 is situated immediately under the squeeze roller 56. When the electrical circuitry section 7 effects reverse rotations of the recording drum 5, the trailing end of the plate P released from the clamping is carried into the storage/transportation mechanism 2.

Next, when the rotational angle position of the recording drum 5 arrives the squeeze roller position, the electrical circuitry section 7 retracts the squeeze roller 56 to detach it from the recording drum 5 (step S36; FIG. 32A). The electrical circuitry section 7 further effects reverse rotations of the recording drum 5, and fixes the rotational angle position of the recording drum 5 at the leading-end clamp position (step S37; FIG. 32B). The leading-end clamp position is identical to the rotational angle position of the recording drum 5 fixed at step S11.

Next, the electrical circuitry section 7 opens the leading-end clamp 52 (step S38; FIG. 32C), and removes the plate P from the recording drum 5 to the storage/transportation mechanism 2 (step S39; FIG. 32D). As described above, when the leading-end clamp 52 is opened, a space is formed between one end portion of the leading-end clamp 52, which lies closer to the storage/transportation mechanism 2 than the other end portion of the leading-end clamp 52, and the outer surface of the recording drum 5. At this step, the operation for removing the plate P from the recording drum 5 is ended.

As described above, according to the cylindrical outer surface scanning apparatus, the trailing end position of a plate is accurately detected when the plate is mounted on the recording drum, and the trailing-end clamp is attached on the recording drum based on the detected trailing end position of the plate. Thus, it is possible to securely stabilize the plate by means of the trailing-end clamp, and stably ensure a gripper margin of the plate by the trailing-end clamp regardless of the plate-to-plate variations which may occur in the manufacturing process. Consequently, it is possible to set a gripper margin smaller than the conventional gripper margin, which is set so as to be long enough in case of the manufacturing variations occur, and obtain a sufficient image recording area of the plate.

In the above-described embodiment, the leading and trailing ends of the plate P are stabilized on the outer surface of the recording drum 5 by the leading-end clamp 52 and the trailing-end clamp 53, respectively, with respect to the circumferential direction of the recording drum 5. The present invention can also be applied to the variant where a vacuum system is used in conjunction with the clamp mechanism. For example, if material permits, the leading end of the plate P is stabilized by the vacuum system in place of the clamp mechanism, and the trailing end of the plate P is stabilized by the clamp mechanism.

While the invention has been described in detail, the foregoing description is in all aspects illustrative and not restrictive. It is understood that numerous other modifications and variations can be devised without departing from the scope of the invention.

1. A cylindrical outer surface scanning apparatus for recording an image on a sheet-shaped image recording material mounted thereon, comprising:
a cylindrical drum having a cylindrical outer surface for mounting the image recording material thereon;
a leading end stabilizing section for positioning a leading end of the image recording material on the outer surface of the drum for stabilization;
winding means for winding the image recording material whose leading end is stabilized by the leading end stabilizing section around the outer surface of the drum in a circumferential direction thereof;
a trailing end detecting section for detecting a position of the trailing end of the image recording material on the outer surface of the drum in the circumferential direction of the outer surface of the drum;
a trailing end stabilizing section provided on the drum so as to be releasable therefrom and movable in the circumferential direction, the section for stabilizing the trailing end of the image recording material on the outer surface of the drum;
a control section for setting a position in the circumferential direction at which the trailing end stabilizing section is attached on the drum, based on the circumferential direction position of the trailing end detected by the trailing end detecting section; and
driving means for attaching the trailing end stabilizing section at the circumferential direction position on the outer surface of the drum set by the control section.

2. The cylindrical outer surface scanning apparatus according to claim 1, wherein
the trailing end detecting section detects the trailing end of the image recording material at a plurality of portions along the cylindrical axis direction of the outer surface of the drum.

3. The cylindrical outer surface scanning apparatus according to claim 1, wherein
the control section sets the circumferential direction position at which the trailing end stabilizing section is attached on the drum such that the trailing end of the image recording material pinched between the trailing end stabilizing section and the outer surface of the drum is constant in length in the circumferential direction.

4. The cylindrical outer surface scanning apparatus according to claim 1, further comprising:
a roller for pressing the image recording material against the outer surface of the drum when the image recording material is wound around the outer surface of the drum by the winding means, wherein
the trailing end detecting section detects the trailing end of the image recording material in a neighborhood of the roller.

5. The cylindrical outer surface scanning apparatus according to claim 1, wherein
the control section sets the circumferential direction position at which the trailing end stabilizing section is attached on the drum by adjusting the circumferential direction position of the trailing end detected by the trailing end detecting section based on a type of image recording material.

6. A cylindrical outer surface scanning method for recording an image on a sheet-shaped image recording material mounted on a cylindrical outer surface of a cylindrical drum, comprising the steps of:
stabilizing a leading end of the image recording material on an outer surface of the drum after positioning;
winding the image recording material whose leading end is stabilized at the leading end stabilizing step around the outer surface of the drum in a circumferential direction thereof;
detecting a position of a trailing end of the image recording material wound around the outer surface of the drum in the circumferential direction of the outer surface of the drum;
setting a position in the circumferential direction at which a trailing end stabilizing member for stabilizing the trailing end of the image recording material on the outer surface of the drum is attached on the drum, based on the circumferential direction position of the trailing end of the image recording material detected at the trailing end detecting step; and
attaching the trailing end stabilizing member at the circumferential direction position of the outer surface of the drum set at the trailing end stabilizing member position setting step.

7. The cylindrical outer surface scanning method according to claim 6, wherein
the trailing end detecting step detects the trailing end of the image recording material at a plurality of portions along the cylindrical axis direction of the outer surface of the drum.

8. The cylindrical outer surface scanning method according to claim 6, wherein
the trailing end stabilizing member position setting step sets the circumferential direction position at which the trailing end stabilizing member is attached on the drum such that the trailing end of the image recording material pinched between the trailing end stabilizing member and the outer surface of the drum is constant in length in the circumferential direction.

9. The cylindrical outer surface scanning method according to claim 6, wherein
the winding step presses a portion of the image recording material against the outer surface of the drum when the image recording material is wound around the outer surface of the drum, and
the trailing end detecting step detects the trailing end of the image recording material in a neighborhood of the portion of the image recording material which is pressed against the outer surface at the winding step.

10. The cylindrical outer surface scanning method according to claim 6, wherein
the trailing end stabilizing member position setting step sets the circumferential direction position at which the trailing end stabilizing member is attached on the drum by adjusting the circumferential direction position of the trailing end detected at the trailing end detecting step based on a type of image recording material.
